(19) United States
(12) Patent Application Publication
(10) Pub. No.: US 2009/0096311 A1
(43) Pub. Date: Apr. 16, 2009

(54) METHOD FOR MAKING STATORS OF POLYPHASE ROTATING ELECTRICAL MACHINES, STATORS OBTAINED BY SAID METHOD

(75) Inventor: Denis Even, Creteil Cedex (FR)

Correspondence Address: Matthew R. Jenkins;Jacox, Meckstroth & Jenkins, 2310 Far Hills Building, Dayton, OH, 45419-1575, US

(73) Assignee: Valeo Equipements Electriques Moteur, Creteil Cedex (FR)

(21) Appl. No.: 11/722,005

(22) PCT Filed: Dec. 12, 2005
(86) PCT No.: PCT/FR05/03106

§ 371 Date: Jun. 18, 2007

(30) Foreign Application Priority Data
Dec. 20, 2004 (FR) 0413611

(51) Int. Cl. H02K 23/26; H02K 15/04

(52) U.S. Cl. 310/198; 29/596

(57) ABSTRACT

A method for making a polyphase rotating electrical machine stator, comprising an assembly of plates, slots, and a corrugated coil including a plurality of phase windings each formed with at least one continuous electrically conductive wire configured in successive recesses comprising a plurality of branches extending in a series of slots and a plurality of linking segments connecting the branches. The invention is characterized in that the method includes at least one first step during which the wires of the phase windings are arranged simultaneously on a dummy rotor and are during that same process configured into recesses, and a second step during which the dummy rotor is used for transferring the coil into the assembly of plates or for forming the stator.

### FIELD OF THE INVENTION

The invention concerns in general the methods for manufacturing stators for polyphase rotary electrical machines such as alternators or an alternator/starter for motor vehicles.

More precisely, the invention concerns, according to a first aspect, a method of manufacturing a stator for a polyphase rotary electrical machine, such as an alternator or alternator/starter for a motor vehicle, this stator comprising a packet of metal sheets perforated centrally by a bore and having an axis of symmetry, recesses passing through axially formed in the packet of metal sheets around the bore, and a corrugated coil comprising a plurality of phase windings each formed by at least one continuous electrically conductive wire conformed in a succession of crenellations comprising a plurality of branches extending in a series of recesses and a plurality of connection segments connecting the branches.

### PRIOR ART

Methods are known for producing stators of this type, in particular through the patent document FR 2 608 334. Each phase winding is first of all shaped by confirmation of the wire in a succession of crenellations, then is placed on an insertion tool, and finally is inserted in the recesses in the packet of metal sheets by means of the tool. The insertion is carried out phase by phase.

The stators formed by this method have, on both sides of the packet of metal sheets, very dense coil ends offering high resistance to the circulation of air. In addition, the coil ends are not symmetrical, one of the coil ends having an axial height greater than that of the other coil end, which is also unfavourable for the circulation of cooling air in these leading out wires.

Moreover, the filling rate of the recesses, that is to say the ratio between the cross-section of the bare conductive wire, usually made from copper, and the complete cross-section of the recess in which there is mounted a recess insulator acting between the edges of the recesses and the wires, is limited to 50%, since the positioning of the branches in the recess is not well controlled during the transfer of the phase windings from the insertion tool to the recesses.

In addition, the forces necessary for the insertion of the conductive wires in the recesses are very high. The phase inserted last must in fact push the phases inserted previously. The forces are not well transmitted from one phase to another. Under some conditions, this may impair the quality of the product.

In this context, the aim of the present invention is to mitigate the faults mentioned above.

### OBJECT OF THE INVENTION

For this purpose, the method of the invention, also in accordance with the generic definition that the above preamble gives it, is essentially characterised in that it comprises at least a first step during which the wires of the phase windings are disposed simultaneously on a dummy rotor and are, during this same operation, conformed in crenellations, the dummy rotor having, on a radially external face, a plurality of radial slots in which the branches of the windings are disposed, and a second step during which the dummy rotor is used for transferring the coil into the packet of metal sheets or for forming the stator.

According to a first embodiment, the second step can be performed by disposing the dummy rotor at the centre of packet of metal sheets and forcing the branches of the windings radially into the recesses from inside to outside.

In this case, the radial slots can extend in respective radial planes regularly distributed around an axis of symmetry of the dummy rotor, the dummy rotor also comprising a plurality of blades disposed in the radial slots, and means of moving the blades radially from inside to outside in the radial slots, the branches of the windings coming to be inserted in the radial slots at the first step on a radially external side of the blades, the blades being moved radially towards the outside at the second step so as to transfer the branches of the radial slots into the recesses.

According to a second embodiment, the stator can be formed at the second step by fixing a cylindrical jacket around the dummy rotor.

Advantageously, the radial slots can be equal in number to the number of recesses.

Preferably, each radial slot can have a circumferential width corresponding to the cross-section of the wire, so that the branches are all aligned radially in the slot.

According to another aspect of the method of the invention, the first step can be performed by depositing the wires of the windings in a first group of consecutive radial slots, from a first axial side of the dummy rotor as far as a second axial side opposite to the first, folding the wires on the second axial side of the dummy rotor in order to form connecting segments, depositing the wires in a second group of consecutive axial slots situated alongside the first, from the second axial side as far as the first axial side, folding the wires on the first axial side in order to form other connecting segments, and so on until a first complete turn of the dummy rotor has been made and a first layer of wires has been formed, all the radial slots being occupied by one branch of a wire, and then in the same way making one or more other turns in order to form one or more other layers of wires in the radial slots.

Preferably each group of radial slots can comprise a number of slots equal to the number of wires used to form the winding at the first step.

According to a first example of a winding sequence, in the first layer, the branches of a given wire can occupy a set of radial slots that is peculiar to this wire and, in the other layer or layers, the branches of this same wire can occupy the same set of radial slots.

Alternatively, in the first layer, the branches of a given wire can occupy a set of radial slots that is peculiar to this wire and, in at least one other layer, the branches of this same wire can occupy another set of radial slots.

In this case, the said other set of radial slots can be offset by one slot with respect to the said set of radial slots.

According to another example of a winding sequence, in the first layer, the branches of a given wire can occupy a first set of radial slots that is peculiar to this wire, in at least a second layer the branches of this same wire can occupy a second set of radial slots different from the first set and, in at least a third layer, the branches of this same wire can occupy a third set of radial slots different from the first and second sets.

Advantageously, the wires of the phase windings can be disposed in the same sequence in all the groups of slots, in a given layer of the winding.

Alternatively, in the first layer, the wires of the phase windings can be disposed in the same first given sequence in all the groups of slots and, in at least one other layer, the wires can disposed in a second sequence.

In this case, the winding can comprise an even number of wires, the said second sequence being obtained from the first sequence by permuting the adjoining wires in pairs.

For example, the number of layers wound in the first sequence can be equal to the number of layers wound in the second sequence.

According to another example of a winding sequence, in at least one layer the wires of the phase windings can be disposed in the same given first sequence in certain groups of slots and in a second given sequence in other groups of slots.

In a variant, the wires used to form the coil at the first step can be cut, generally at their middle, after the first step.

For example, the first step can be performed by winding an even number of wires each having an entry end and an exit end, these wires being joined in pairs after the first step by electrically connecting to each other the entry ends of the wires in one and the same pair and the exit ends of the wires in one and the same pair.

According to yet another aspect of the method of the invention, the parts of the wires constituting the connecting segments between a first group of radial slots and a second group following the first in the order of winding can comprise first mutually parallel segments forming a flat cluster emerging from the first group of radial slots in a direction inclined with respect to the axis of the dummy rotor as far as an axial top of the connection segments, and second mutually parallel segments forming a flat cluster extending the first segments from the said top as far as the second group of radial slots, aslant with respect to the axis of the dummy rotor, so that the clusters of the first and second segments overlap mutually in a substantially triangular region at the top of the connection segments.

In this case, the second segments can extend on a radially external side of the first segments in the triangular overlap region.

Advantageously, the triangular overlap regions of a given layer can be inserted between the triangular overlap regions of the previous layer, without overlapping them even partially.

Moreover, the recesses in the stator can have a circumferential width corresponding to the cross-section of the wire, all the branches being aligned in the same recess.

According to yet another aspect of the method of the invention, the branches can be locked in the recesses by deformation of the cross-section of at least some branches.

In this case, the operation of deformation of the cross-section of the branches can be performed after insertion of the branches in the radial slots of the dummy rotor and/or after insertion of the branches in the recesses in the stator.

Finally, the wire can have a round cross-section.

According to a second aspect, the invention relates to a stator for a polyphase rotary electrical machine, such as an alternator or alternator/starter for a motor vehicle, this stator comprising a packet of metal sheets perforated centrally by a bore and having an axis of symmetry, recesses passing through axially formed in the packet of metal sheets around the bore and each having a plurality of reception positions distributed radially over several levels, and a corrugated coil comprising a plurality of phase windings each formed by at least one continuous electrically conductive wire conformed in a succession of crenellations comprising a plurality of branches disposed at reception positions in a series of recesses and a plurality of connection segments connecting the branches, characterised in that each wire is wound in a spiral around the bore and forms several turns each corresponding to a turn of the bore, the branches in one and the same turn all being disposed in reception positions at the same level.

Advantageously, the coil can be wound so that the wires of the windings pass through a first group of consecutive recesses, from a first axial side of the stator as far as a second axial side opposite to the first, and are then folded on the second axial side of the stator in order to form connection segments, then pass into a second group of consecutive recesses situated alongside the first, from the second axial side as far as the first axial side, then are folded on the first axial side in order to form other connection segments, and so on over a first complete turn of the stator constituting a first layer, the branches of the first layer occupying the radially external reception positions of all the recesses, the wires being wound in the same way on one or more other turns and constituting one or more other layers whose branches occupy radially more internal reception positions in the recesses.

Preferably, the parts of the wires constituting the connection segments between a first group of recesses and a second group of recesses following the first in the winding order can comprise first mutually parallel segments forming a flat cluster emerging from the first group of recesses in a direction inclined with respect to the axis of the stator as far as an axial top of the connection segments, and second mutually parallel segments forming a flat cluster extending the first segments from the said top as far as the second group of recesses, aslant with respect to the axis of the stator, so that the clusters of the first and second segments overlap mutually in a substantially triangular region at the top of the connection segments.

In this case, the second segments can extend on a radially external side of the first segments in the triangular overlap region.

In addition, the triangular overlap in the regions of a given layer can be inserted between the triangular overlap regions of the previous layer, without overlapping them, even partially.

Advantageously, the first and/or second segments issuing from the same end of a given recess can form a radial alignment on a circumferential side of the recess, or two radial alignments in a V on both circumferential sides of the recess.

According to a first variant for obtaining ventilated coil ends, the connection segments connecting a first group of recesses to a second group of recesses are relatively long, so that their first and second segments are mutually separated and define between them a plurality of radial air passages.

According to a second variant for obtaining compact coil ends, the connection segments connecting a first group of recesses to a second group of recesses are relatively short, so that their first and second segments are mutually contiguous or mutually only slightly separated.

Moreover, the recesses in the stator can have a circumferential width corresponding to the cross-section of the wire, all the branches being aligned in the same recess.

According to another aspect, the branches can be locked in the recesses by deformation of the cross-section of at least some branches.

Finally, the wire can have a round cross-section.

### BRIEF DESCRIPTION OF THE FIGURES

Other characteristics and advantages of the invention will emerge clearly from the description that is given of it below, by way of indication and in no way limiting, with reference to the accompanying figures, among which:

FIG. 1 is a developed view of a wire of a phase winding conformed in a succession of crenellations,

FIG. 2 is a partial view of a stator according to the invention, in section in a plane perpendicular to its axis of symmetry,

FIG. 3 is a side view of a stator according to the invention,

FIG. 4A is a perspective view of the dummy rotor used in the first embodiment of the invention, depicted at the end of the first step, once the phase windings have been coiled in the radial slots,

FIG. 4B is a view in a radial direction of the dummy rotor of FIG. 4A disposed at the centre of the packet of metal sheets, at the start of the second step,

FIG. 5A is a simplified perspective view of one end of the stator in figure 3, showing the arrangement of the connection segments issuing from one and the same recess, the right-hand part of the figure showing relatively longer segments making it possible to obtain ventilated coil ends as illustrated on the right-hand part of FIG. 5C, the left-hand part of the figure showing relatively shorter segments making it possible to obtain compact coil ends as illustrated on the left-hand part of FIG. 5C,

FIG. 5B is a radial view in the direction of the arrow VB in FIG. 5A,

FIG. 5C is a radial view of part of the coil end of the stator, the left-hand part of the figure illustrating a first configuration of the segments in which these are practically contiguous, the right-hand part illustrating a second configuration of the segment in which these segments are mutually separated,

FIG. 6 is a view similar to that in FIG. 2, showing the deformation of the wires in the recesses of the stator,

FIG. 7 is a half view in axial section of the dummy rotor in FIGS. 4A and 4B,

FIG. 8 is a half view in section of the dummy rotor of FIG. 7, in a plane perpendicular to the axis of symmetry of the dummy rotor, considered in the direction of the arrows VIII in FIG. 7,

FIGS. 9A to 9F are developed representations of the various sequences of winding of the wires of the phase windings on the dummy rotor in FIGS. 4A and 4B, corresponding to different variant embodiments of the invention, each line showing the sequence of winding of a layer of the winding, the final position of the layer in the recesses of the stator (detail A), and the position of the layer in the slots of the dummy rotor (detail B), the detail C summarising the distribution of the phases in the recesses, each of FIGS. 9A to 9F being cut into four plates, (9A1 to 9A4, 9B1 to 9B4, etc), the segments being interrupted at the limits a to f extending to the points a′ to f′ in the adjoining plates (for example the segments of plates 9A1 extending in 9A2 and the segments of the plates 9A3 in 9A4),

FIGS. 10A and 10B are outline diagrams showing in a developed fashion the respective circumferential positions of the connection segments of two successive layers of the winding coiled in accordance with the sequences of FIGS. 9A to 9F,

FIG. 11 is a schematic representation in radial section of part of the winding after fitting in the stator, showing that it is possible to vary the inclination of the coil end,

FIG. 12 is an outline diagram showing the means for achieving crossings of wires on the machine in FIGS. 13 to 17,

FIG. 13 is a general view of the machine for coiling the wires of the phase windings on the dummy rotor at the first step,

FIG. 14 is a front perspective view of the machine in FIG. 13, the means of manipulating the dummy rotors not being shown,

FIG. 15 is a view in longitudinal section of the machine in FIG. 13, considered in the direction of the arrows XV in FIG. 13, the dummy rotor being shown at the centre of the wire-guide means, gripped by the movement means,

FIG. 16 is an enlarged view of part of the wire-guide means in FIG. 14, considered in the front longitudinal direction,

FIG. 17 is a view in section of the wire-guide means, considered in the direction of the arrow XVII in FIG. 14,

FIGS. 18A to 18G are partial schematic representations of certain elements of FIG. 13, illustrating part of the sequence of winding the wires of the phase windings on the dummy rotor,

FIG. 19 is an exploded partial view, in section, of a stator obtained in accordance with a second embodiment of the invention, considered in a plane perpendicular to the axis of symmetry of the stator, and

FIG. 20 is a view in axial section of the stator in FIG. 19, the jacket and the dummy rotor being shown assembled.

### EXAMPLE EMBODIMENTS OF THE INVENTION

The method aims to manufacture stators 1 for polyphase rotary electrical machines, more particularly stators for alternators or alternator/starters for motor vehicles.

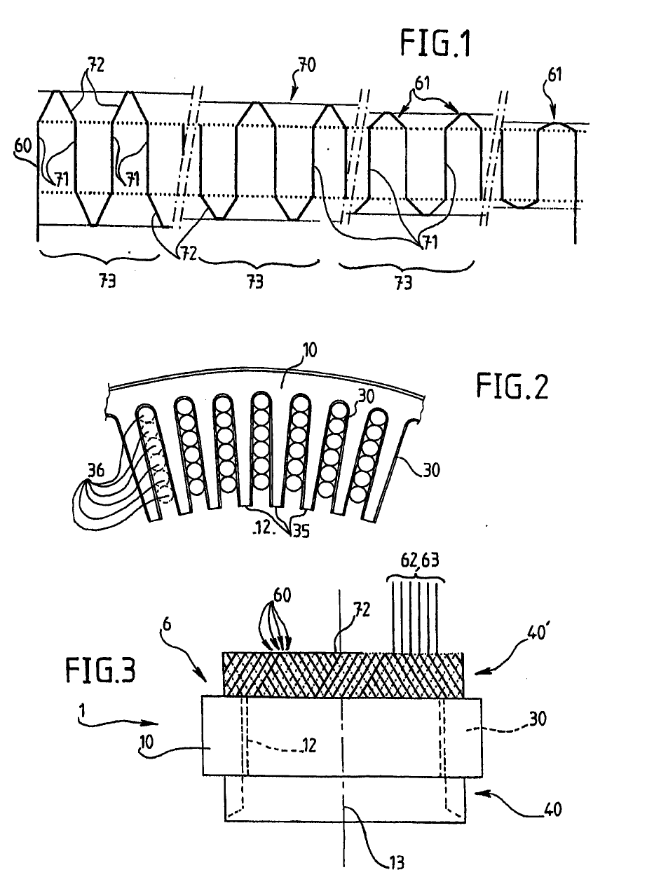

The stator 1 comprises an annular packet of metal sheets 10 perforated centrally by a bore 12 and having an axial axis of symmetry 13, axial recesses 30 provided in the packet of metal sheets 10 regularly distributed around the bore 12, and a corrugated coil 6 (FIGS. 2 and 3).

The recesses 30 are separated from one another by axial ribs 35 referred to as teeth.

These recesses 30 pass axially right through the packet of metal sheets 10 since they extend over the entire axial length of the packet of metal sheets 10 and are open at both opposite axial ends thereof.

The coil 6 comprises a plurality of phase windings 70 typically each consisting of at least one electrically conductive continuous wire 60 (FIG. 1). The wire has for example a round cross-section made from copper covered with an insulator such as enamel of any diameter, typically between 1.5 and 2.12 mm.

In a known fashion, a recess insulator, visible in FIG. 2, is interposed between the wires and the edge of the recesses.

The wire 60 is formed in a succession of crenellations 61, as illustrated in FIG. 1, so that each phase winding 70 comprises a succession of branches 71, substantially rectilinear, disposed parallel to one another, connected by connection segments 72. More precisely, each branch 71 has an end connected by a connection segment 72 to the end of the previous branch 71 situated on the same side, and an opposite end connected by another connection segment to the end of the following branch situated on the same side.

The recesses 30 each offer a plurality of reception positions 36 for the lateral branches 71 staged radially over several levels (FIG. 2).

Each winding 70 is disposed on the stator so that the lateral branches 71 are disposed at reception positions 36 in a series of recesses 30 in the stator 1, the connection segments 72 forming coil ends 40 and 40′ respectively on a first and second axial side of the stator 1.

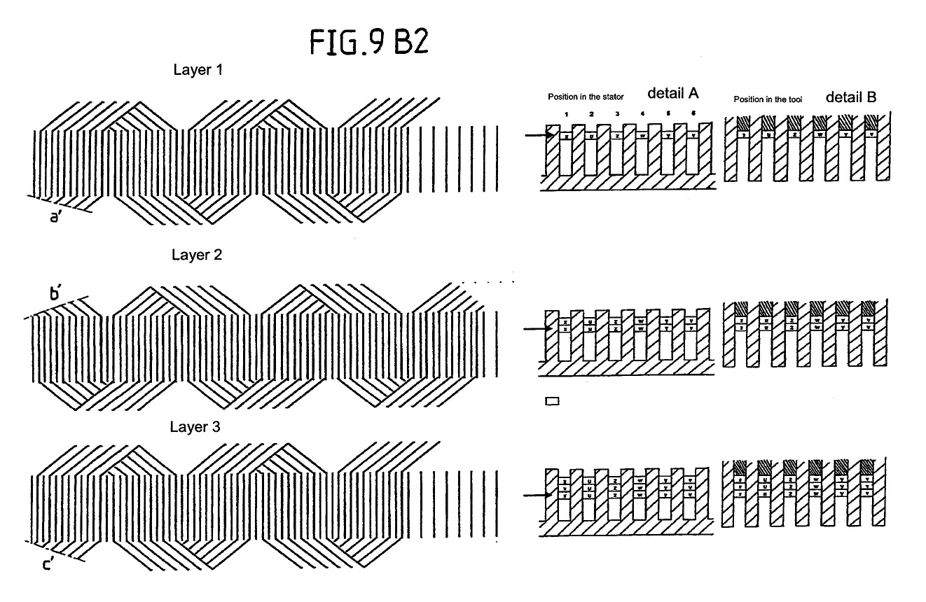

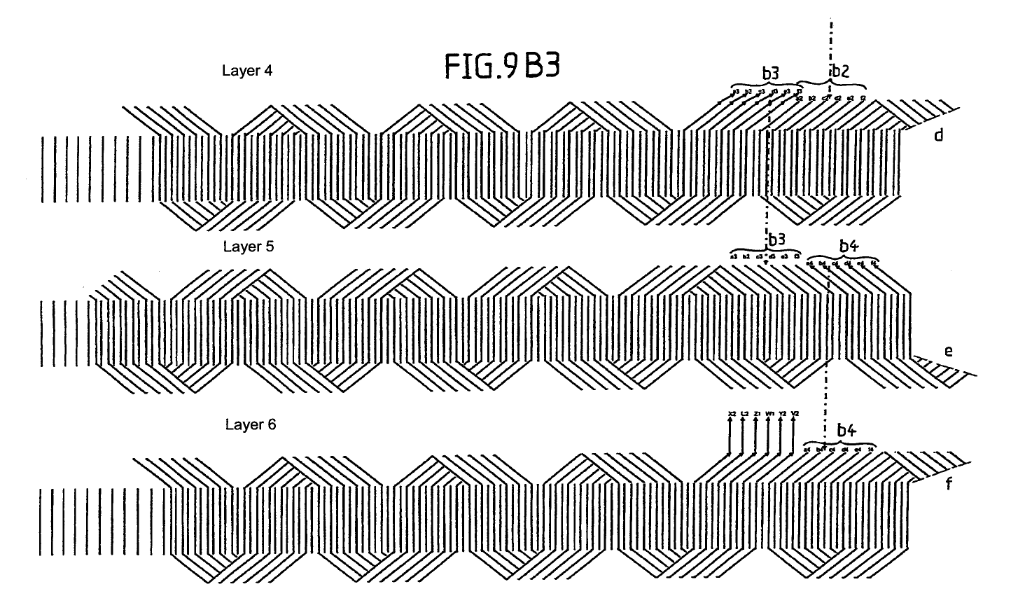

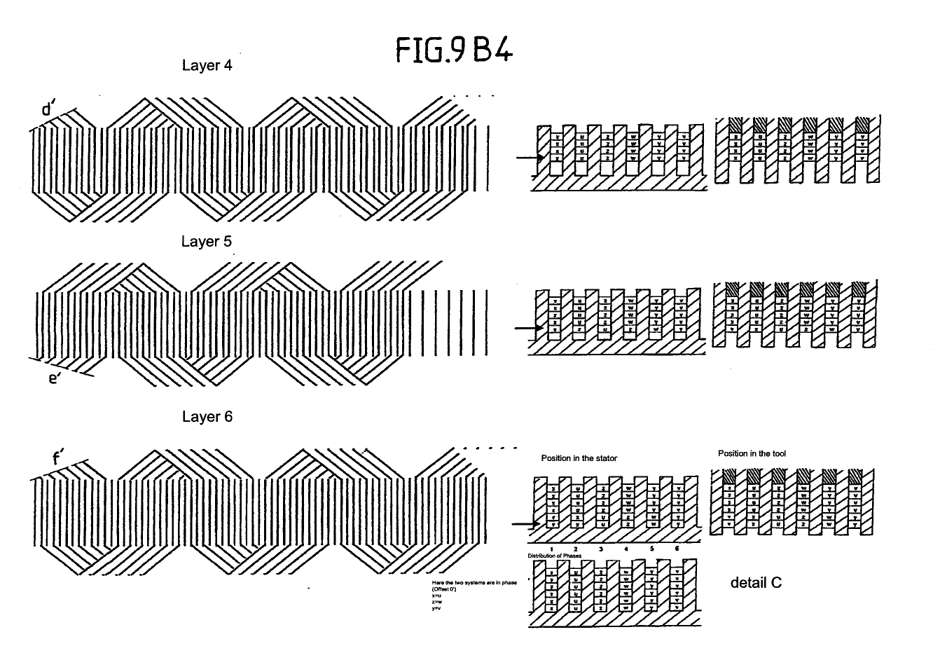

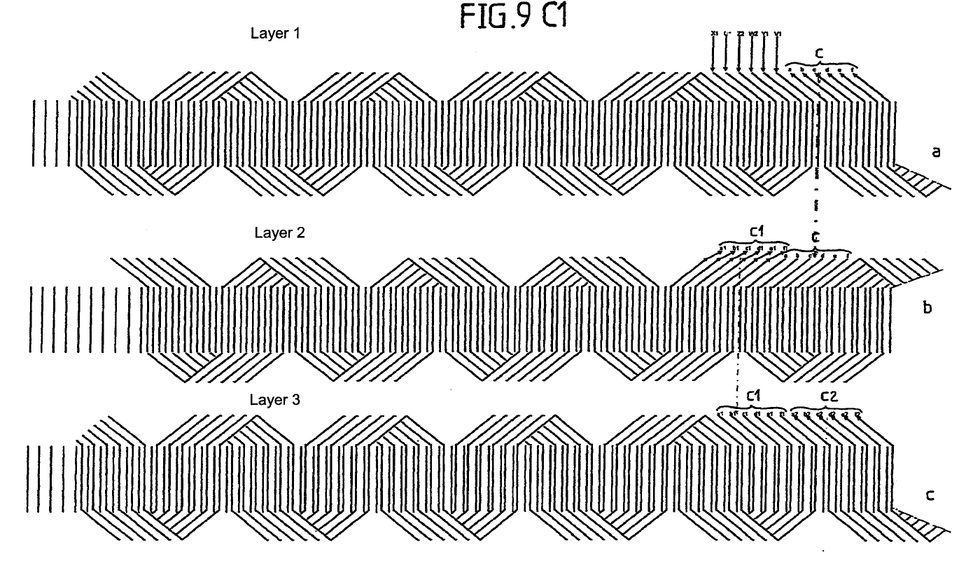

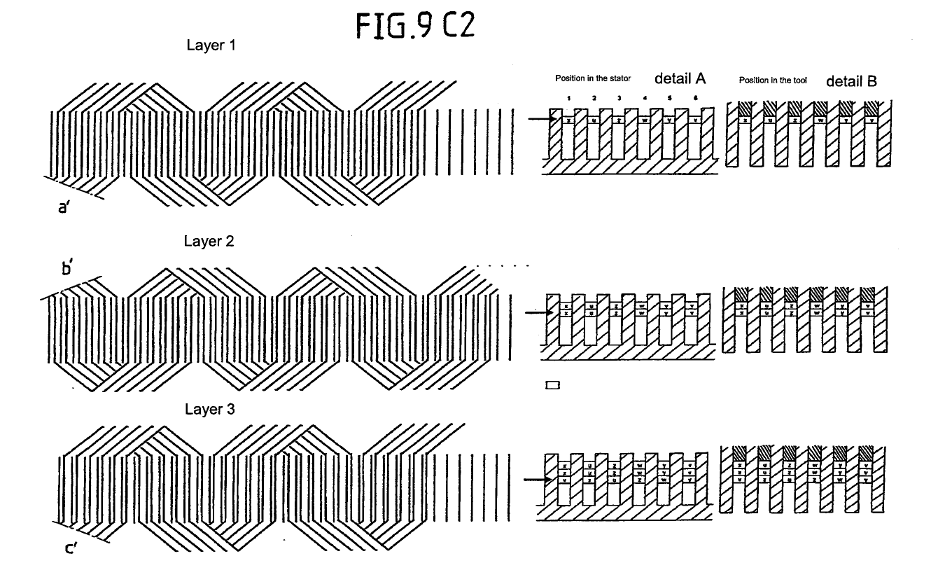

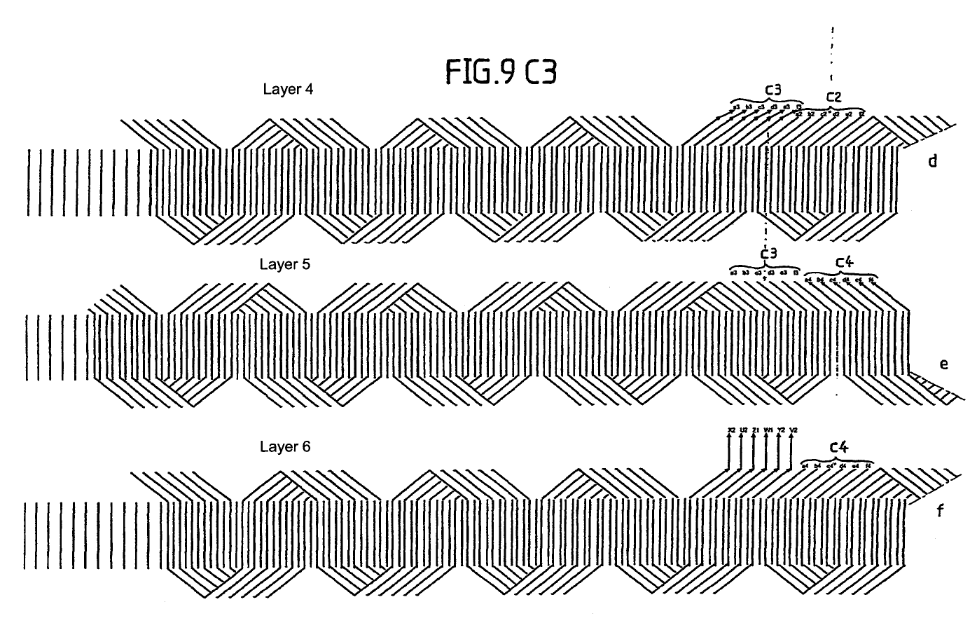

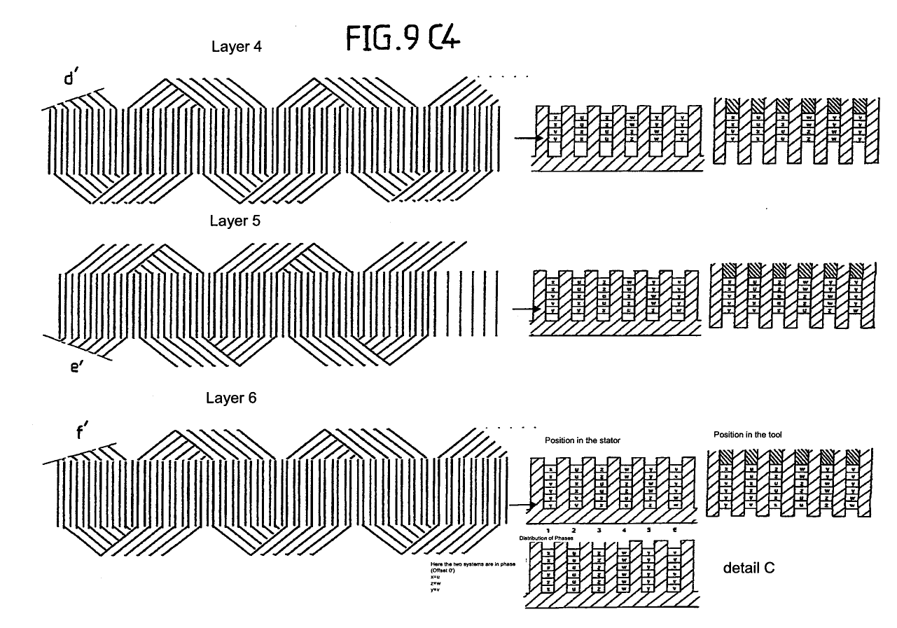

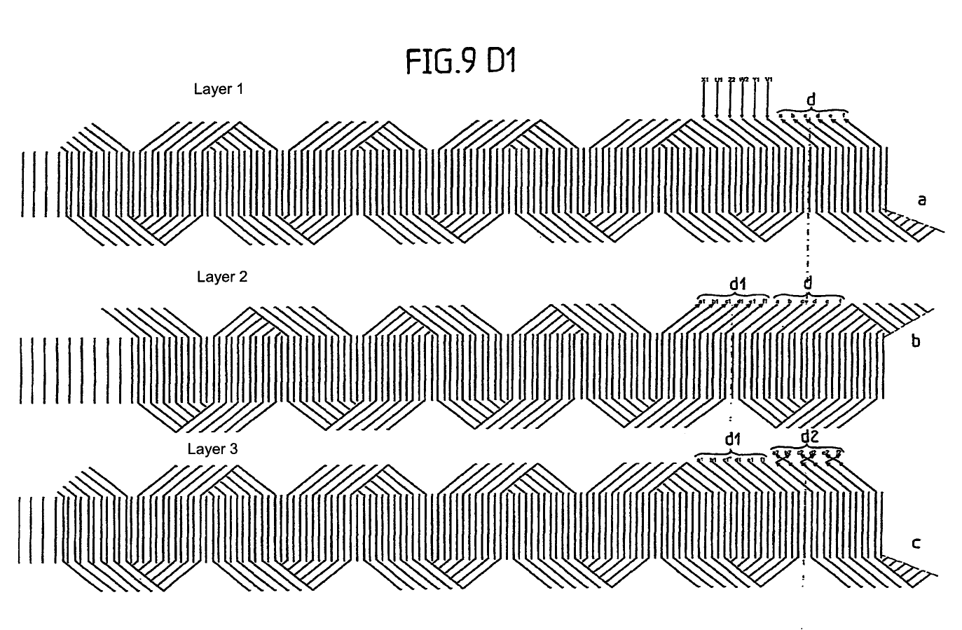

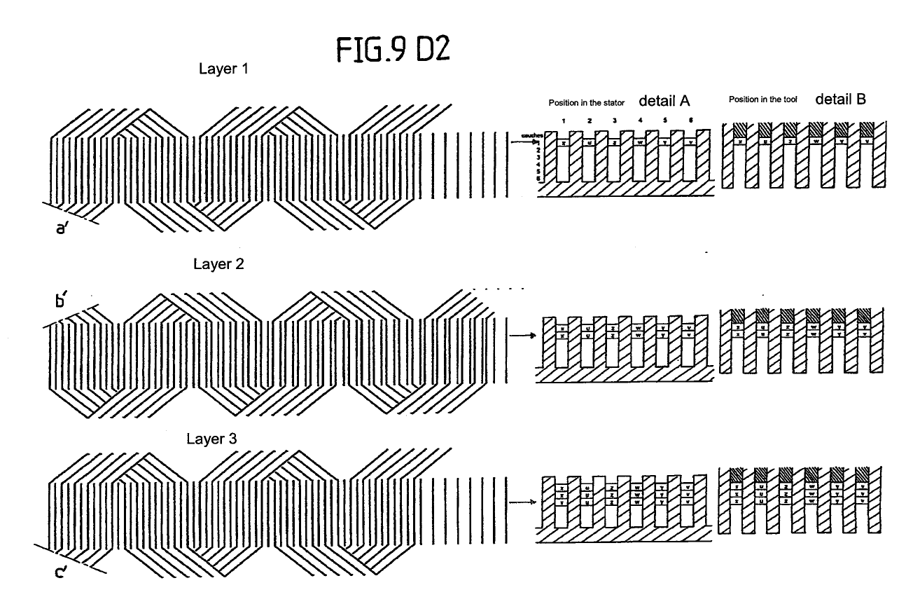

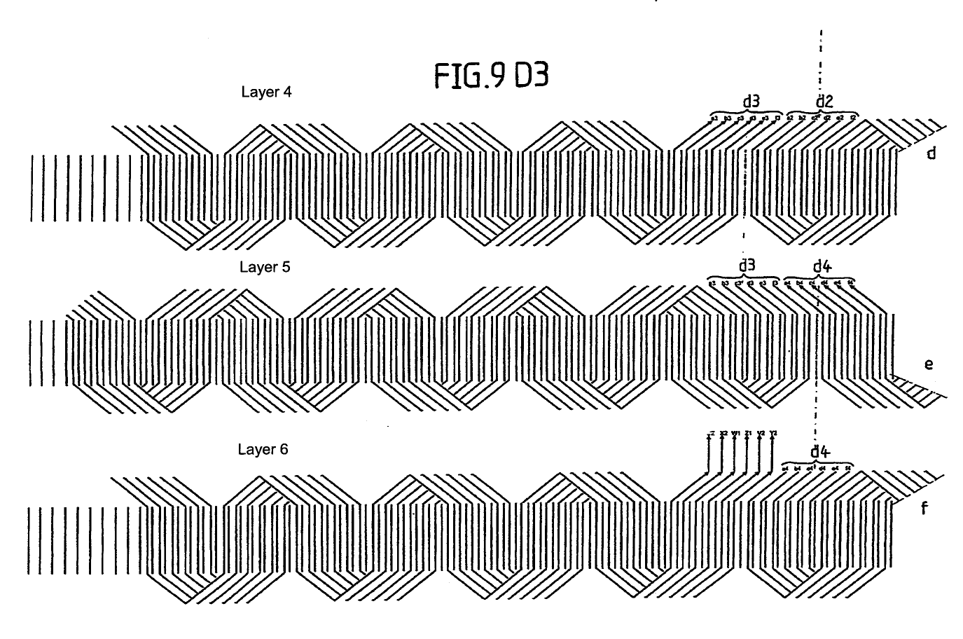

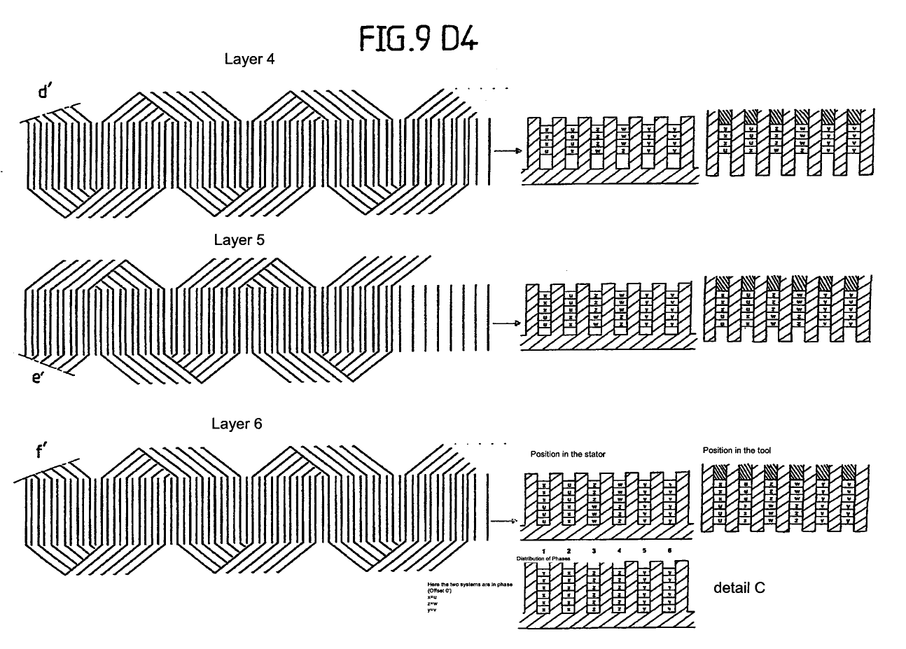

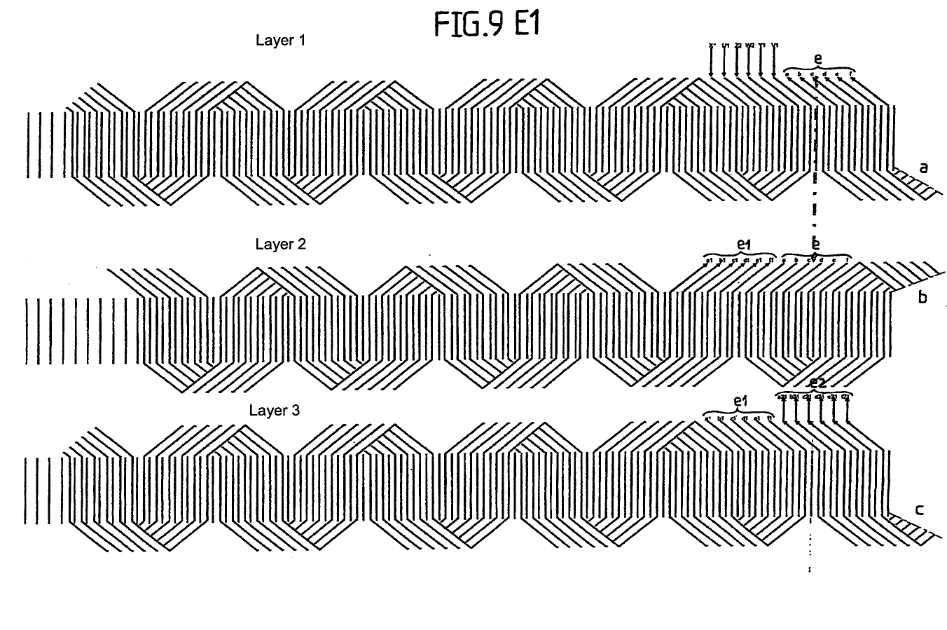

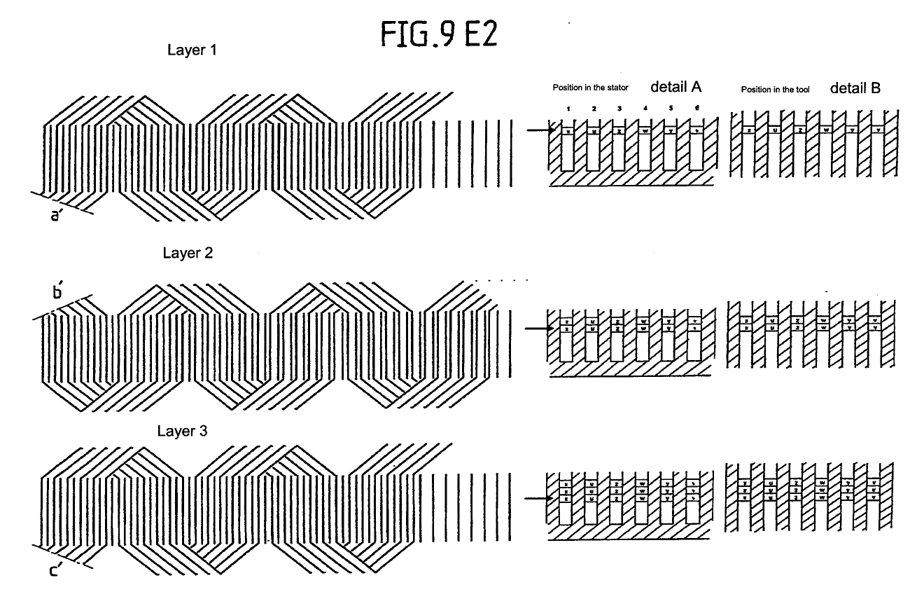

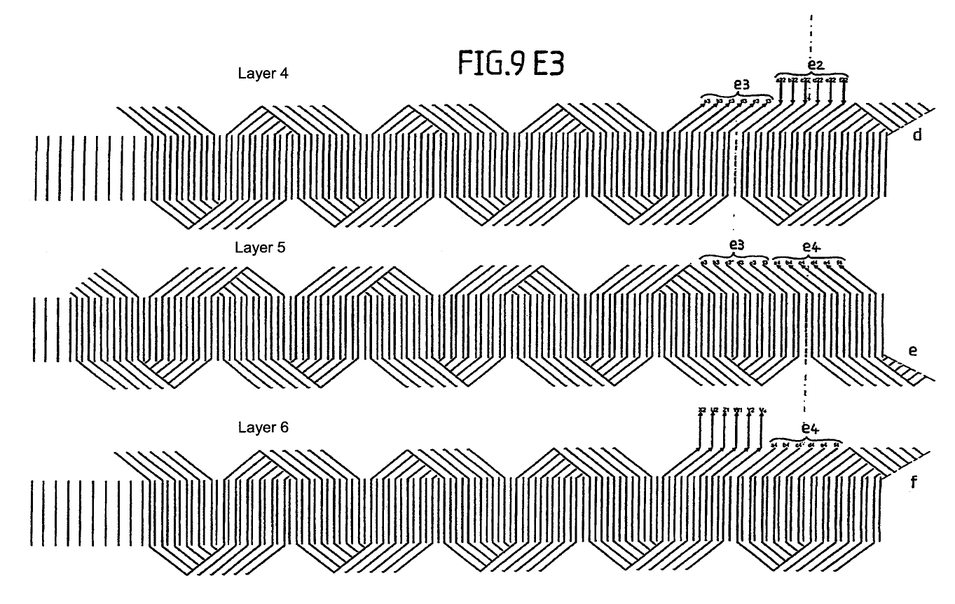

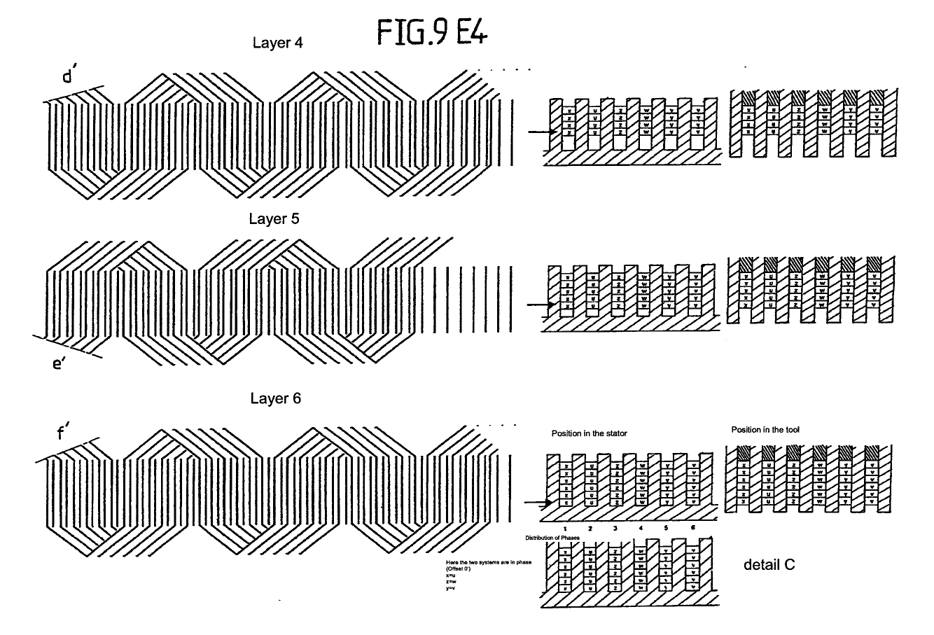

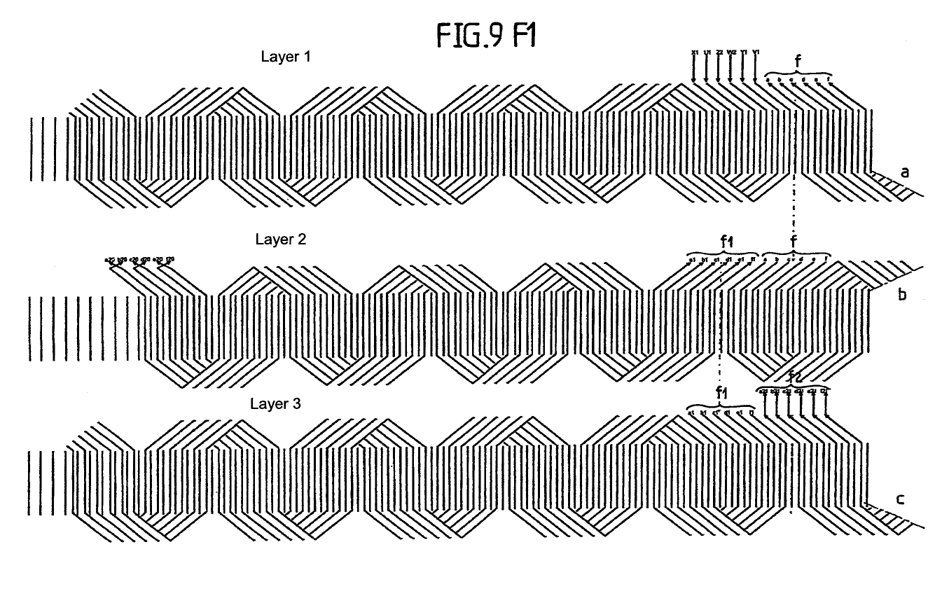

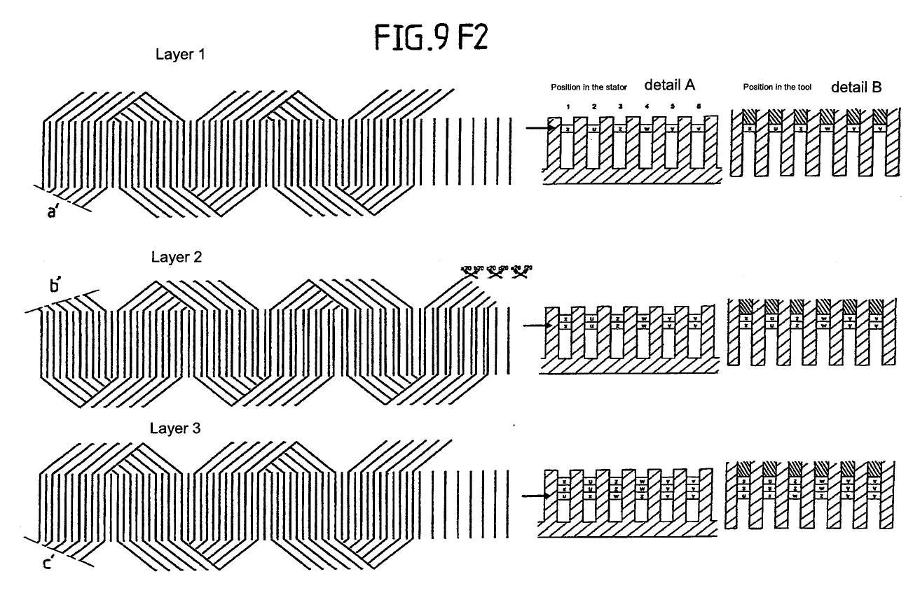

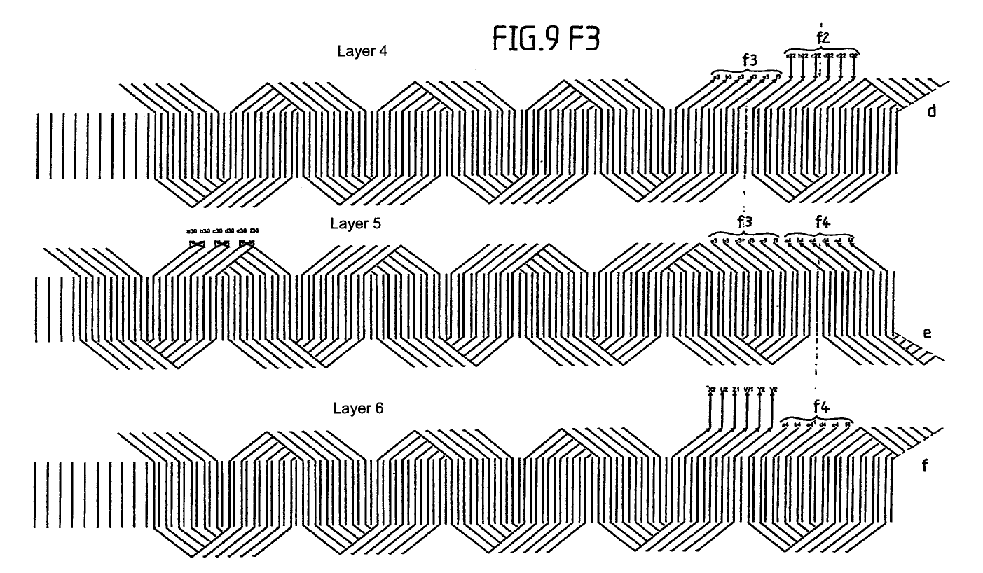

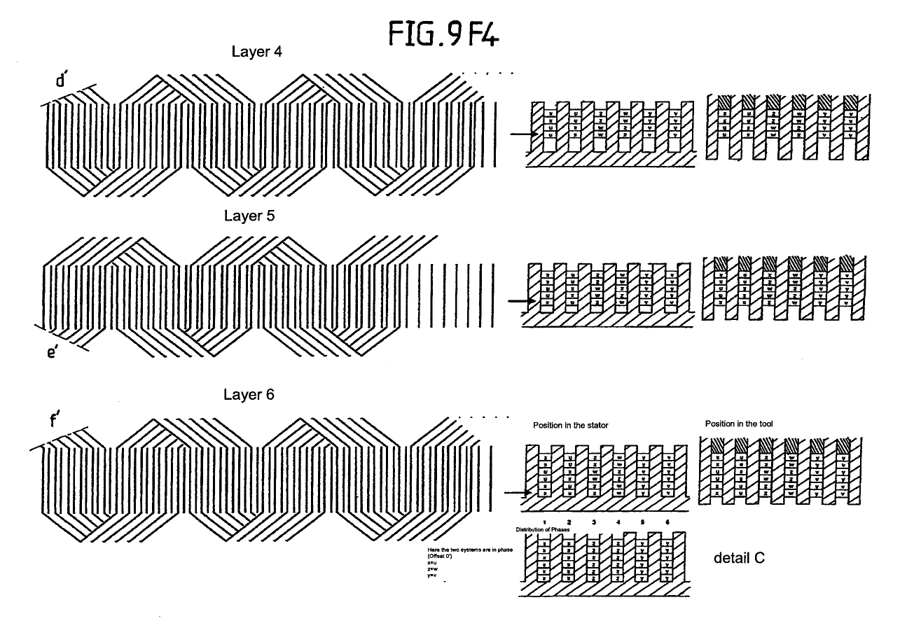

The recesses 30 are generally divided into several series, each series being exclusively associated with a given winding 70 and receiving exclusively the branches of this winding. The recesses 70 of the same series are distributed regularly around the stator 1, the positions of the series of recesses 30 associated with the various windings being derived from one another by an angular offset by one recess, as shown by FIG. 9A.

However, in certain cases the same phase winding can be distributed in two series of recesses, as will be seen below.

The wire or wires 60 of each winding 70 are each wound in a spiral around the bore 12 and thus form several turns 73 each corresponding to one turn of the bore 12. These turns 73 are coaxial with the axis of symmetry 13 of the stator.

The turns 73 of the various wires 60 are superimposed radially in a predetermined order, and are disposed in the recesses 30 in a concentric fashion, the turns 73 inserted first being disposed radially to the outside and the turns 73 inserted last being disposed radially to the inside of the packet of metal sheets 10.

According to the invention, the method comprises at least a first step during which the wires 60 of the phase winding 70 are disposed simultaneously on a dummy rotor 80 and are, during this same operation, conformed in crenellations, and a second step during which the dummy rotor 80 is used for transferring the winding 6 into the packet of metal sheets 10 (first embodiment) or for forming the stator 1 (second embodiment).

### Description of the Dummy Rotor and of the Method of Inserting Wires of the Phase Windings in the Dummy Rotor

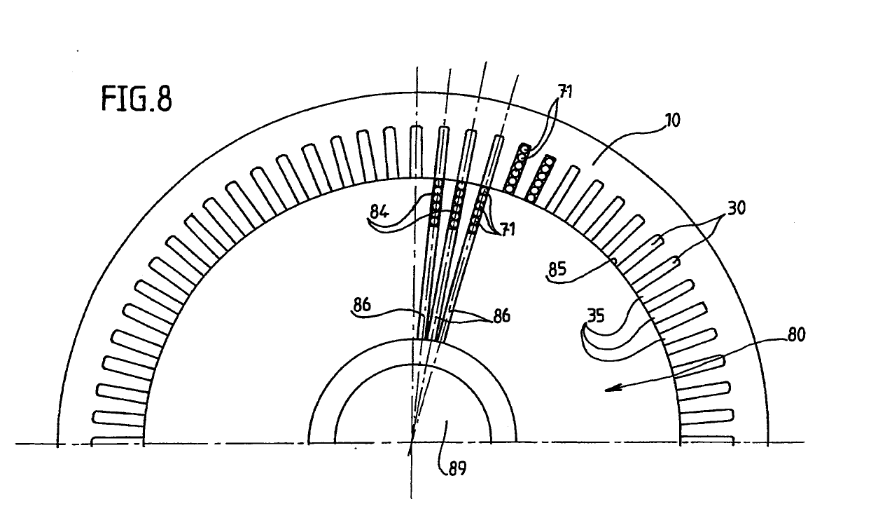

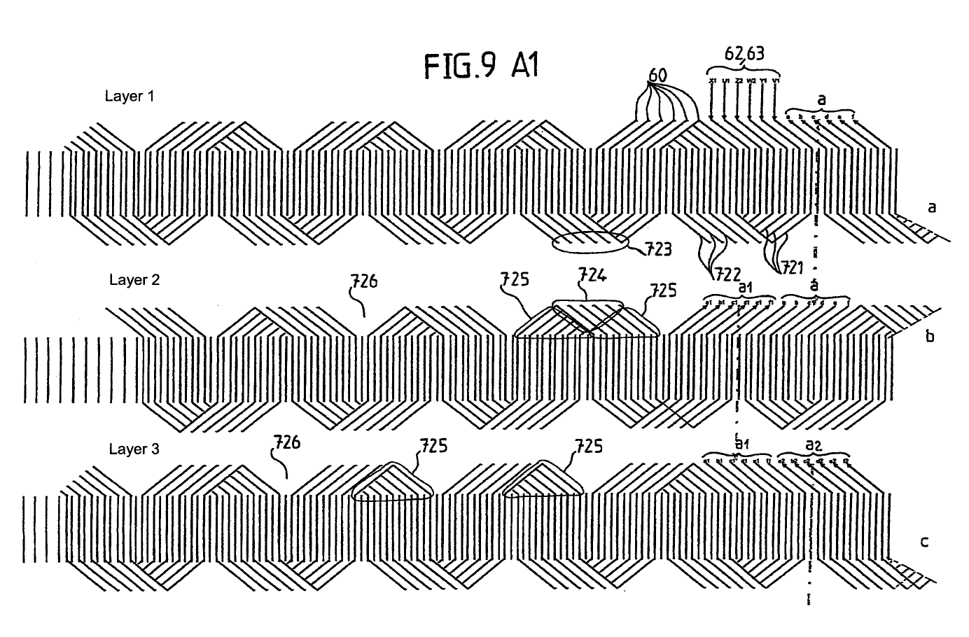

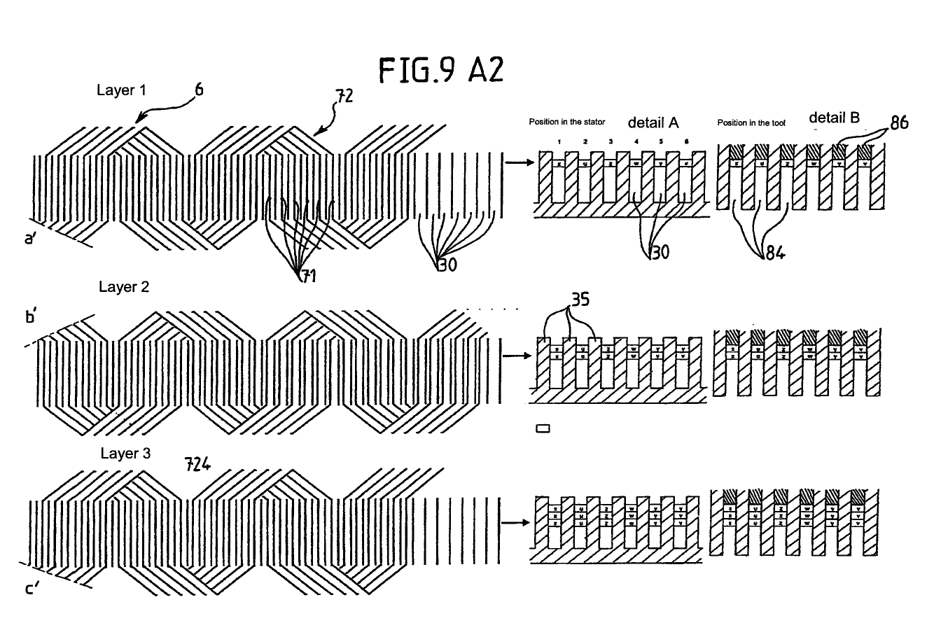

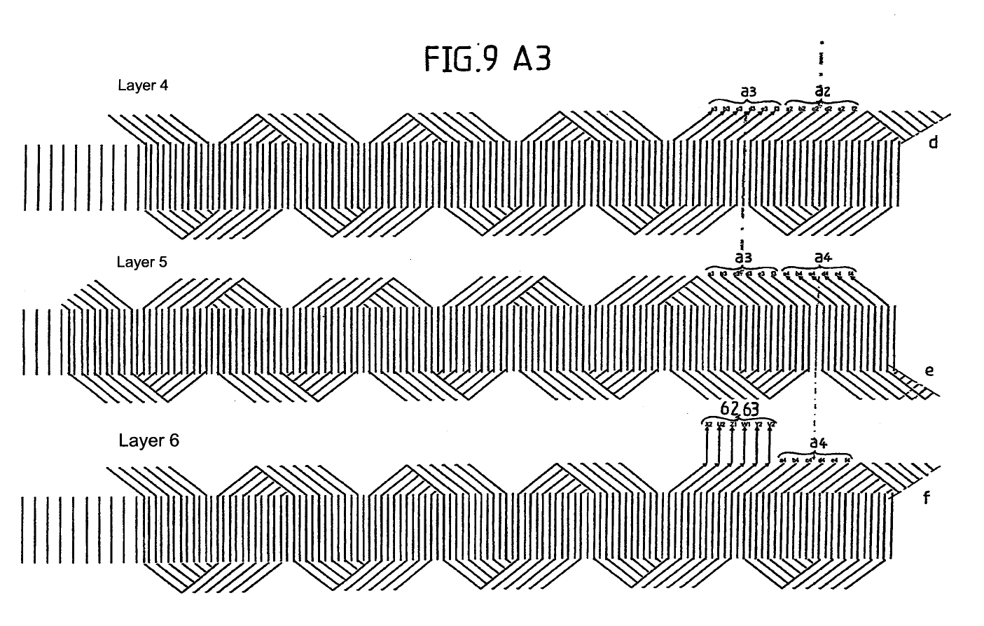

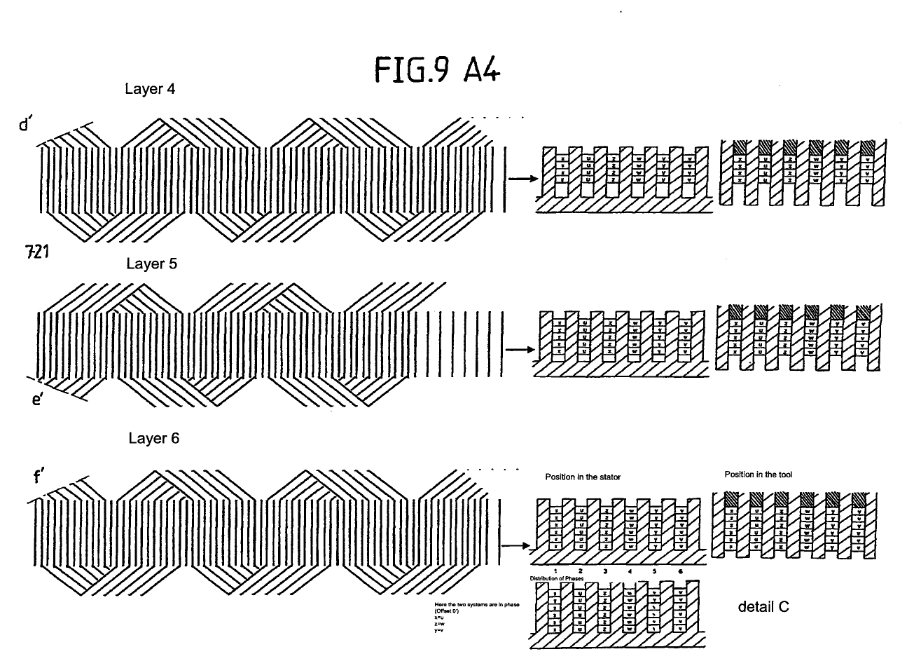

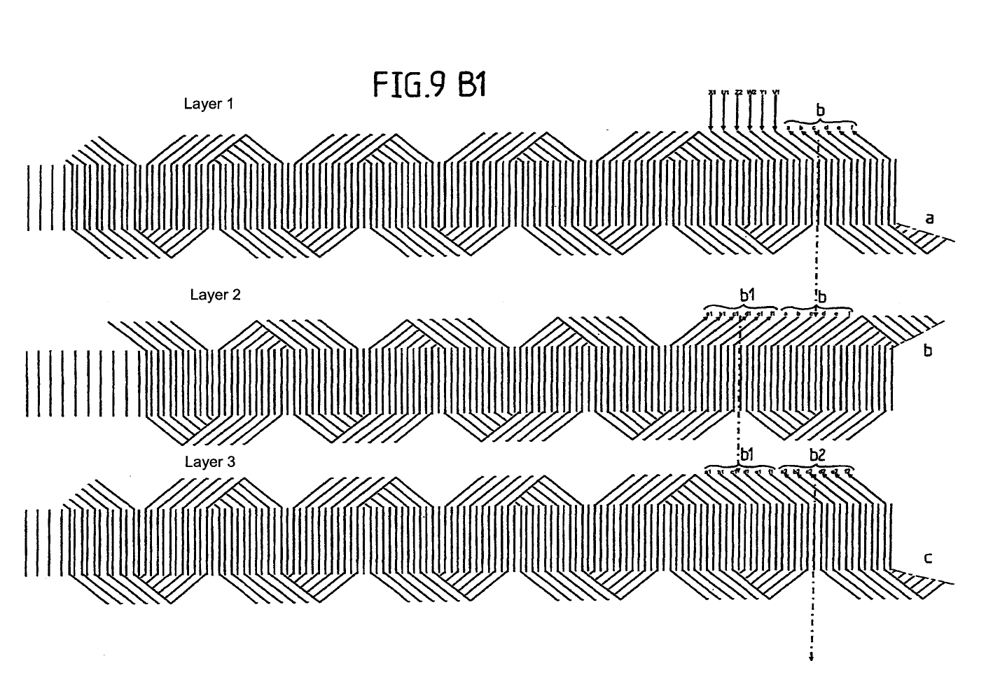

In the two embodiments, use is made of a substantially cylindrical dummy rotor 80 having on a radially external face 85 a plurality of radial slots 84 in which the branches 71 of the windings 70 are disposed (FIGS. 7 and 8).

The radial slots 84 are equal in number to the number of recesses 80 and are regularly distributed around the dummy rotor 80. They extend over the entire axial length of the dummy rotor and are open radially towards the outside and at the two axial ends of the dummy rotor 80.

Moreover, each radial slot 80 has a circumferential width corresponding to the cross-section of the wire, so that the branches 70 are all aligned radially in the slot 84 and occupy a plurality of radial positions distributed radially over several levels.

The first step is performed by means of a winding machine 90 that will be described later, according to a winding sequence, several variants of which are depicted in FIGS. 9A to 9F, by depositing simultaneously the wires 60 of the various windings 70 in a first group of consecutive radial slots 84, from a first axial side of the dummy rotor 80 as far as a second axial side opposite to the first, by folding the wires 60 on the second axial side of the dummy rotor 80 in order to form connection segments 72, depositing the wires 60 in the second group of consecutive axial slots 84 situated alongside the first, from the second axial side as far as the first axial side, folding the wires 60 on the first axial side in order to form other connection segments 72, and so on until a first complete turn of the dummy rotor 80 has been made and a first layer of wire 60 has been formed.

All the radial slots 84 are then occupied by a branch 71 of a wire 60, this branch occupying the innermost radial position in the slot (first line, detail B in FIGS. 9A to 9F).

One or more other turns are then made in the same way in order to form one or more other layers of wires 60 in the radial slots 84.

At each additional turn, a branch 71 comes to be inserted in each slot 84, occupying the radial position immediately outside the branch 71 inserted at the previous turn (see last line, detail B in FIGS. 9A to 9F).

There are therefore made as many turns as there are radial positions in a slot 84.

It can be seen clearly in FIGS. 9A to 9F that each group of radial slots 84 comprises a number of slots equal to the number of wires used to perform the winding operation, this number being able to be equal to the number of phase windings 70 or different from this, as will be seen below.

### First Example of a Winding Sequence (FIG. 9A)

FIG. 9A corresponds to an example embodiment in which six wires are used to produce the coil, the radial slots having six radial positions, the winding operation being performed in six turns, and the stator thus produced comprising six phase windings each of six turns, denoted x, u, z, w, y and v (one wire per phase). The entries 62 of the wires of the phase windings are denoted x1, u1, z1, w1, y1 and v1, and their respective exits 63 x2, u2, z2, w2, y2 and v2.

The winding sequence is such that the radial slots 84 are divided into several sets associated exclusively with one winding 70 (see details A and C).

Thus, in the first layer, the branches 71 of a given phase winding 70 occupy a set of radial slots 84 that is peculiar to this winding, and in the other layers the branches 71 of this same phase winding occupy the same set of radial slots 84.

To this end, the wires 60 of the phase winding 70 are disposed in the same sequence in all the groups of slots 84, in a given layer of the coil 6, and this sequence is the same in all the layers of the coil 6.

The slots 84 associated with a given phase winding 70 are distributed regularly around the dummy rotor and are spaced apart by six slots (for example slots 1, 7, 13, 19 etc).

### Second Example of a Winding Sequence (FIG. 9B)

FIG. 9B also corresponds to an example embodiment in which six wires are used for producing the coil, the radial slots having six radial positions, the winding operation being performed in six turns, and the stator thus produced comprising six phase windings each of six turns (one wire per phase).

In the example embodiment in FIG. 9B, the branches 71 of one and the same phase winding 70 are distributed in two sets of radial slots 84.

More precisely, in the first four layers, the branches 71 of a given phase winding 70 occupy a first set of radial slots that is peculiar to this winding and, in the last two layers, the branches 71 of this same phase winding 70 occupy another set of radial slots.

This other set of radial slots 84 is here offset by one slot with respect to the said first set of radial slots, towards the right in the representation in FIG. 9B. This offset could also be by one slot towards the left.

The electric currents running through the phase windings 70 resulting from the winding sequence in FIG. 9B are out of phase with respect to the electric currents running through the phase windings 70 resulting from the winding sequence in FIG. 9A.

### Third Example of a Winding Sequence (FIG. 9C)

FIG. 9C also corresponds to an example embodiment in which six wires are used to produce the coil, the radial slots having six radial positions, the winding operation being performed in six turns, and the stator thus produced comprising six phase windings each of six turns (one wire per phase).

In the example embodiment in FIG. 9C, the branches 71 of a phase winding 70 are distributed in three sets of radial slots 84.

Thus, in the first two layers, the branches 71 of a given phase winding occupy a first set of radial slots 84 that is peculiar to this winding, in the following two layers the branches 71 of this same phase winding 70 occupy a second set of radial slots 84 different from the first set, and in the last two layers the branches 71 of this same phase winding 70 occupy a third set of radial slots different from the first and second sets.

The second set of slots is offset by one slot to the right in FIG. 9C with respect to the first, and the third set of slots is offset by one slot to the right in FIG. 9C with respect to the second.

The electric currents passing through the phase winding 70 resulting from the winding sequence in FIG. 9C are out of phase with respect to the currents running through the phase windings 70 resulting from the winding sequence in FIG. 9A or the sequence 9B.

### Fourth Example of a Winding Sequence (FIG. 9D)

FIG. 9D still corresponds to an example embodiment in which six wires are used for producing the coil, the radial slots having six radial positions, the winding operation being performed in six turns.

In the winding sequence depicted in FIG. 9D, the wires of the phase windings are disposed in the same given first sequence in all the groups of slots three first layers, and are disposed in a second sequence in the other three layers.

The said second sequence is obtained from the first sequence by distributing the wires in several mutually adjoining pairs of wires, and permuting the adjoining wires in pairs, between the third and fourth layers (points a2, b2, c2, d2, e2, f2).

Because the number of wound layers according to the first sequence is equal to the number of wound layers according to the second sequence, a stator is obtained with three phase windings of six turns each comprising two parallel wires.

This is because the branches 71 of the first wire in a pair are disposed at the first three layers in a first set of radial slots 84, and are disposed at the last three layers in a second set of radial slots 84 offset by one slot compared with the first set.

The branches 71 of the second wire in the same pair are disposed at the first three layers in the second set of radial slots 84 and are disposed at the last three layers in the first set of radial slots 84.

The first and second wires therefore have electric currents running through them that are in phase, and thereby constitute one and the same phase winding with two parallel wires.

The respective entry ends of these two wires are mutually connected electrically, as are their exit ends.

The winding sequence in FIG. 9D could comprise an offset by one notch of the type described in relation to FIG. 9C.

### Fifth Example of a Winding Sequence (FIG. 9E)

FIG. 9E still corresponds to an example embodiment in which six wires are used for producing the coil, the radial slots having six radial positions, the winding operation being performed in six turns.

In the winding sequence depicted in FIG. 9E, the wires 60 of the phase winding 70 are cut at their middle after the first step, between the third layer and the fourth layer.

The first half of the wire 60 comprises a first end (entry or exit x1, u1, z2, w2, y1, v1) and extends over the first three layers as far as a second end (entry or exit a21, b21, c21, d21, e21, f21), in a set of radial slots peculiar to the corresponding phase winding.

The second half of the wire 60 comprises a third end (entry or exit a22, b22, c22, d22, e22, f22) and extends over the last three layers as far as a second exit end in the same set of radial slots as the first half wire.

The second and third ends are created when the wire 60 is cut.

For the purpose of facilitating this cutting, a loop is created with the wire 60 between the third and fourth layers at the time of winding, this loop then being cut.

Finally, the first and third ends belonging to the two halves of wires issuing from the same wire are electrically connected, and the second and third ends belonging to the two halves of wires issuing from the same wire are electrically connected.

In this way six phase windings 70 are created, each of three turns, with two parallel wires.

### Sixth Example of a Winding Sequence (FIG. 9F)

As before, FIG. 9F corresponds to an example embodiment in which six wires are used for producing the coil, the radial slots having six radial positions, the winding operation being performed in six turns.

The winding sequence depicted in FIG. 9F combines certain characteristics of the sequences in FIGS. 9D and 9E.

As in the variant embodiment in FIG. 9E, each wire is cut between the third layer and the fourth layer.

In addition, the first halves of wires occupying the first three layers are distributed in pairs and undergo crossings in pairs in the middle of the second layer.

Likewise, the second halves of wires occupying the last three layers undergo crossings in pairs at the middle of the fifth layer, the second halves of wires being distributed in the same pairs as the first halves of wires, so that each wire returns to its initial position.

Finally, the two first ends of the two wires in the same pair and the two third ends of the two wires in the same pair are electrically connected, that is to say four ends in all mutually connected. Likewise, the two second ends of two wires in the same pair and two fourth ends of two wires in the same pair are electrically connected, that is to say again four ends in all mutually connected.

Three phase windings of three turns are then obtained, each comprising four wires in parallel.

The winding sequences in FIGS. 9A, 9B, 9C and 9E each make it possible to obtain six phase windings offset by 30°, able to be connected in threes in a star or delta.

The winding sequences in FIGS. 9D and 9F each make it possible to obtain three phase windings offset by 60°, able to be connected in a star or delta.

### Formation and Arrangement of Connection Segments 72

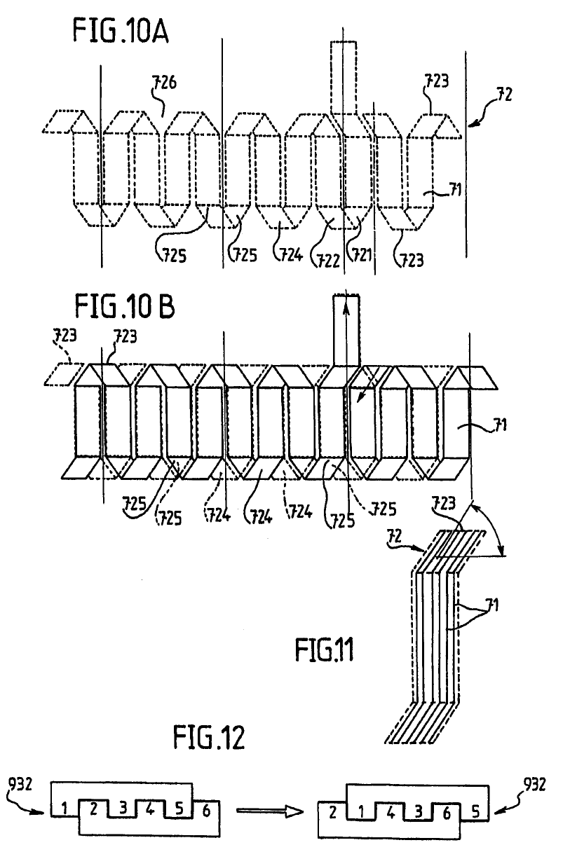

According to a particularly important aspect of the invention illustrated in FIGS. 10A/B and in FIGS. 9A to 9F, the parts of the wires 60 constituting the connection segments 72 between a first group of radial slots 84 and a second group following the first in the winding order comprise first mutually parallel segments 721 forming a flat cluster emerging from the first group of radial slots 84 in a direction inclined with respect to the axis of the dummy rotor 80 as far as an axial top 723 of the connection segments 72, and second mutually parallel segments 722 forming a flat cluster extending the first segments 721 from the said top 723 as far as the second group of radial slots 84 aslant with respect to the axis of the dummy rotor 80, so that the clusters of the first and second segments 721/722 overlap mutually in a substantially triangular region 724 at the top of the connection segments 72.

These flat clusters extend in a sector of a cylinder coaxial with the axis of symmetry of the dummy rotor.

The flat cluster can also each extend in a plane substantially perpendicular to the slots from which the segments issue (for the first segments 721) or perpendicular to the slots towards which the segments are directed (for the second segments 722).

FIGS. 10A/B depict the first two turns of the sequence of winding a plurality of wires 60 on the dummy rotor 80, for example six wires in the example embodiments in FIGS. 9A to 9F. The wires 60 are not shown individually but in the form of a band developing in crenellations around the dummy rotor, this band representing the path of the wires. It is indicated thereby that the wires 60 are wound simultaneously and are held mutually parallel in a flat cluster throughout the winding operation, as can be seen in FIGS. 9A to 9F. Each numbered vertical portion of the band corresponds to the passage of the beam through a group of radial slots.

It can be seen in FIG. 10A that the winding is performed towards the left from the entries of the wires. The first segments 721 of the connection segments 72 connecting the first group of slots 84 to the second group of slots 84 are oriented downwards and towards the left in FIG. 10A from the exit from the slots 84. The wires 60 are then folded whilst remaining mutually parallel, all on the same side, and extend aslant upwards and towards the left in FIG. 10A as far as the slots in the second group. All the folds of the wires form the axial top 723 intended to form the axial end of the coil end of the stator, this top being disposed approximately between the first and second groups of radial slots 84, so that the first and second segments 721 and 722 of the same wire are symmetrical with respect to the vertical passing through the fold of the wire in the representation in FIG. 10A.

It can be seen in FIGS. 9A to 9F that the second segment 722 of the wire situated furthest to the right overlaps the first segment 721 of all the other wires, that is to say five wires for a winding produced with six wires. The second segment 722 of the wire situated immediately to its left overlaps the first segments 721 of all the wires situated to the left, that is to say four wires if the winding is produced with six wires. The second segment 722 of the wire situated furthest to the right does not overlap the first segment 721 of the other wires.

The segments of the connections 72 can therefore be divided into three zones. The overlap zone 724 has a double thickness and the shape of an isosceles triangle whose axial vertex 723 constitutes an edge, the vertex opposite to this edge pointing towards the radial slots. On two sides of the overlap zone 724, there are two lateral zones 725 having a single thickness (one wire), substantially triangular in shape, extending between one side of the overlap zone and the groups of radial slots 84.

It should be noted that the connection segments 72 separating the groups of slots 1 and 2 and the connection segments separating the groups of slots 3 and 4 (see FIG. 10A) are separated by a triangular-shaped empty space 726.

The other connection segments 72 separating other groups of slots are formed in the same way as described above.

It can be seen clearly in FIG. 10B that the triangular overlap zones 724 of a given layer are inserted between the triangular overlap zones 724 of the previous layer, without overlapping them even partially, in the empty spaces 726 left between the connection segments 72.

In addition, the lateral zones 725 of the connection segments 72 of the second layer overlap the lateral zones 725 of the connection segments of the first layer, as can be seen in FIG. 10B.

If the coil comprises an even number of layers, the radial thickness of the parts of the coil intended to form the coil ends of the stator 1 is uniform all around the dummy rotor 80.

On the other hand, if the coil comprises an odd number of layers, the parts of the coil intended to form the coil ends of the stator 1 have local radial protrusions.

It should be noted that this respective arrangement of the overlap zones 724 of the successive layers is obtained by alternately winding the layers in one direction and then in the opposite direction, as can be seen in FIGS. 9A to 9F. This is because it is clear from FIG. 9A that the first layer is wound towards the left from the entries of the wires, that the second layer is wound towards the right, the third towards the left, and so on.

According to another aspect of the invention, it will be noted that the second segments 722 extend on a radially external side of the first segments 721 in the triangular overlap zone 724, and this in all the connection segments 72 of all the layers.

### First Embodiment of the Stator

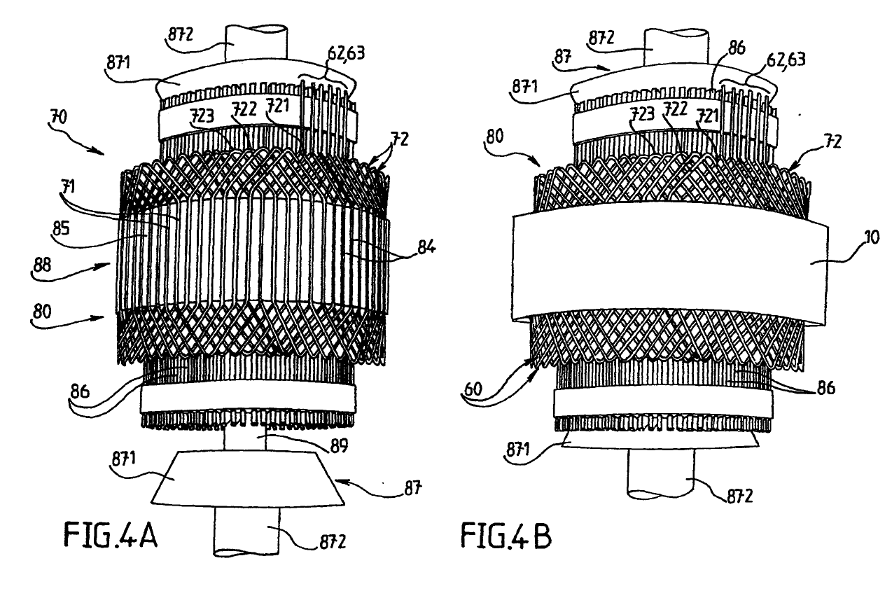

It can be seen in FIGS. 4A, 7 and 8 that the dummy rotor 80 comprises in this embodiment a cylindrical part 88 defining the radially external face 85 in which the radial slots 84 are formed, a plurality of blades 86 disposed in the radial slots 84, and means 87 of moving the blades 86 radially from inside to outside in the radial slots 84.

During the first step, the blades 86 are disposed at the bottom of the radial slots 84, the branches 71 of the windings 70 coming to be inserted in these radial slots 84 on a radially external side of the blades 86, as can be seen in the left-hand half of FIG. 7.

At the second step, the insertion of the windings 70 in the recesses 30 in the stator is performed by disposing the insertion tool 80 at the centre of the packet of metal sheets 10 (FIG. 4B), so that each radial slot 84 is situated opposite a recess 30, by forcing the branches 71 radially in the recesses 30 from inside to outside.

To this end, the blades 86 are moved radially towards the outside by the means 87 provided for this purpose (see the right-hand half of FIG. 7, which shows the dummy rotor with the blades 86 substantially in mid travel).

As shown by FIG. 7, each blade 86 extends in a radial plane with respect to the axis of the dummy rotor 80 and comprises a central part 861 engaged in one of the radial slots 84, and two end parts 862 axially extending the central part 861 of the two sides of the cylindrical part 88.

The end parts 862 of the blades 86 are delimited on a radially internal side by bevelled edges 863, so that the bevelled edges 863 of the various blades define on each side of the cylindrical part 88 a hollow truncated cone 864, converging towards the said cylindrical part 88, coaxial with the axis of symmetry of the dummy rotor 80.

The means 87 of moving the blades 86 comprise two pushers 871 in a truncated cone able to move along the axis of symmetry of the dummy rotor 80, and actuators 872 for axially moving the said pushers 871.

The pushers 871 have shapes conjugate with those of the hollow truncated cone 864.

The actuators 872 consist typically of jacks each provided with an axially movable rod, the pushers being fixed to the rods. The jacks are able to move the rods in order to apply the pushers 871 axially against the bevelled edges 863 forming the hollow truncated cones 864, these pushers thus urging the blades 86 in the direction of a separation towards the outside. The movement of the pushers and blades is visible by comparing the left and right halves of FIG. 7.

The central parts 861 of the blades 86 then push the lateral branches 71 into the recesses 30, all the phase windings 70 thus being fitted on the stator 1 in a single operation.

In this embodiment, the parallelism of the branches 71 is particularly well controlled throughout the various steps. These branches are kept parallel in the radial slots 84 of the insertion tool 80, then during the transfer of the tool towards the recesses 30.

Moreover, the actuators 872 making it possible to separate the blades 86 are offset and are not situated at the centre of the tool 80. This is a significant advantage because the size of the stator tends to decrease.

In addition, the radial insertion of the turns makes it possible to fit the turns without torsion thereof during the insertion, so that they do not deform in return once the insertion has ended.

Finally, the dummy rotor 80 is provided with a central spindle 89 fixed to the cylindrical part 88, extending axially beyond the blades 86. This central spindle 89 serves as a guide for the pushers 871.

### Second Embodiment of the Stator

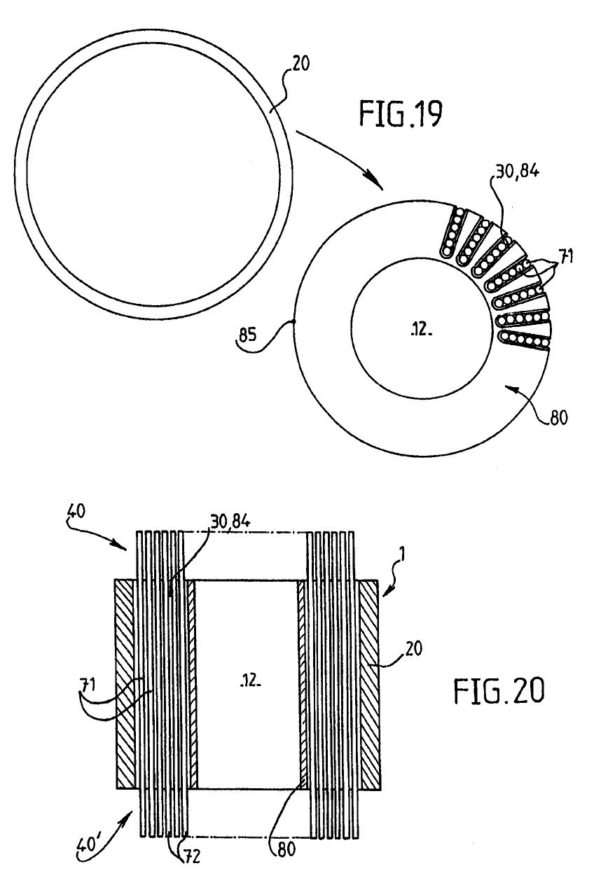

In this second embodiment, illustrated in FIGS. 19 and 20, the stator 1 is formed at the second step by fixing a cylindrical jacket 20 around the dummy rotor 80, the latter becoming an element making up the stator 1.

The cylindrical jacket 20 has an axial length equal to that of the dummy rotor and an inside diameter slightly less than the outside diameter of the dummy rotor 80.

The dummy rotor 80, as can be seen in FIG. 20, has a general cylindrical shape, with a constant outside diameter over its entire axial height, and is perforated axially by a cylindrical aperture constituting the bore 12 of the packet of metal sheets 10, the radial slots 84 for their part constituting the recesses 30 in the packet of metal sheets 10.

The radial slots 84 extend practically over the entire radial thickness of the dummy rotor, from the radially external face to the radially internal face delimiting the bore 12. These slots are closed on an internal side by a partition that is thin compared with the radial thickness of the dummy rotor 80, and are closed on an external side by the jacket 20.

The dummy rotor does not, in this second embodiment, have any movable blades 86, the branches 71 entirely filling the slots 84, as far as the partitions closing these slots on an internal slide.

The jacket 20 is disposed around the dummy rotor 80 by thermal expansion, this jacket 20 being first of all heated to a temperature such that its inside diameter becomes greater than the outside diameter of the dummy rotor 80, then the jacket 20 being slipped axially around the dummy rotor 80, and finally the jacket 80 being cooled, which causes a constriction of the jacket on the dummy rotor 80 because of the reduction in the inside diameter of the jacket 20.

The inside diameter of the jacket 20 is chosen so that the connection between the dummy rotor and the jacket is particularly strong.

According to a variant embodiment, the step of heating the jacket is replaced with a step of cooling the dummy rotor 80 so as to reduce the outside diameter of the dummy rotor sufficiently to make it possible to slip on the jacket 20.

### Machine for Coiling the Wires of the Phase Windings on the Dummy Rotor

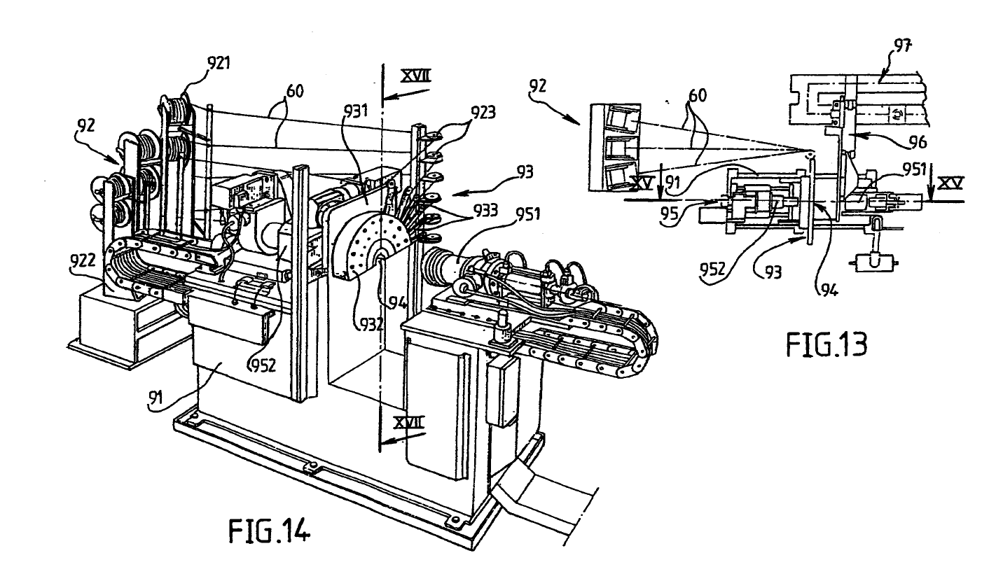

This machine, as can be seen in FIG. 13, comprises principally a frame 92, a magazine 92 for storing the wires 60 in coils, means 93 of guiding the wires 60 from the magazine 92 as far as a winding station 94, means 95 for moving the dummy rotor 80 axially to the winding station 94, and handling means 96 for transferring the dummy rotor 80 between a storage area 97 and the winding station 94.

It can be seen in FIGS. 14, 16 and 17 that the guidance means 94 comprise a vertical support plate 931 rigidly fixed to the frame 91, a front plate 932 having the form of a half ring rigidly fixed on a front side of the support plate, fixed guide arms 933 extending radially from a top edge, in an arc of a circle, of the front plate 932, and radial guide tubes 934 mounted so as to slide radially on the front plate in line with the guide arms 933.

The winding station 94 is situated at the centre of the front plate 932, the edge thereof in the form of an arc of a circle being turned upwards and centred on an axis X-X′.

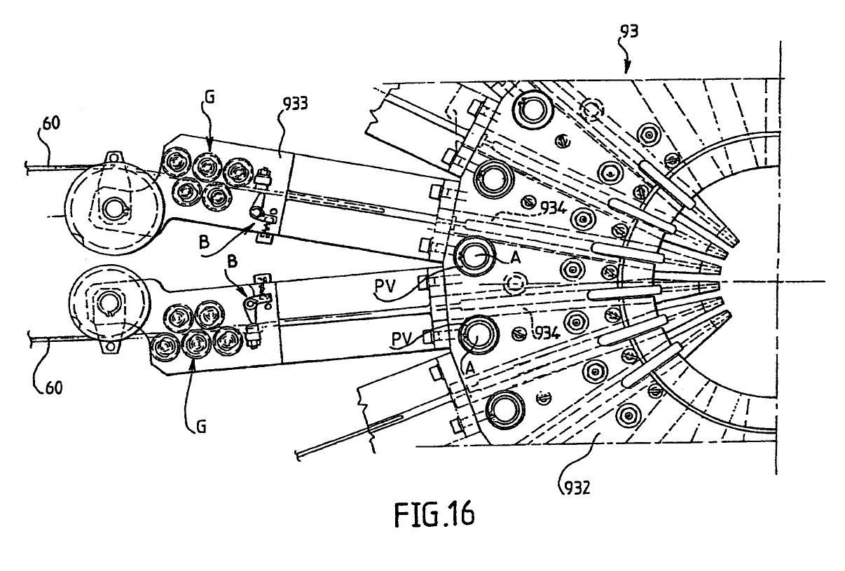

Each wire 60 extends from the magazine 92 as far as the external end of one of the guide arms 933, then radially along this arm 933 as far as the associated tube 934, and then radially inside the tube as far as the winding station 94 (FIG. 16).

Each guide arm 933 carries rollers G aligned on two opposite sides of the wire 60 in order to straighten this wire and make it rectilinear (FIG. 16) and means B for allowing the movement of the wire 60 radially towards the centre of the front plate 932 whilst blocking the movement of the wire 60 in the opposite direction.

The guide means 93 also comprise (FIG. 17) means 935 for simultaneously moving all the tubes 934, these means comprising, for each tube 934, a rotation axis A parallel to the axis X-X′ and passing through the front plate, a front pinion PV mounted for rotation on the front plate about the axis A and meshing with an external thread provided on the tube 934 (see also FIG. 16), and a rear pinion PR fixed to one end of the rotation axis A opposite to the front pinion PV. These means also comprise a drive member C in the form of an arc of a circle of axis X-X′ able to move in rotation about the axis X-X′ with respect to the front plate 932 and having internal teeth meshing with all the rear pinions PR, and a motor M driving the member C in rotation by means of external teeth provided on a radially external face thereof.

The motor M drives the member C in rotation about the axis X-X′, in the clockwise or anticlockwise direction, the member C then driving the front pinions PV in rotation with respect to the front plate, which causes the radial movement of the guide tubes 934, towards the inside or towards the outside depending on the direction of rotation of the member C.

The guide means 93 also comprise (FIG. 17) means 936 for tamping the wires in the slots of the dummy rotor 80. These means 936 comprise radial blades L mounted so as to be able to move radially on the front plate 932, each associated with a guide tube 934, and a guide plate PG perpendicular to the axis X-X′ mounted so as to be able to move in rotation about the axis X-X′ on the support plate 931.

The guide plate PG carries a plurality of arched slots FA forming cams in which there are engaged lugs E fixed to the radial blades L, the rotation of the plate PG causing the movement of the lugs E along the slots and the radial movement of the blades L.

The guide plate PG carries on a rear side a rib in an arc of a circle N having external teeth meshing with a toothed wheel RD, this wheel being driven in rotation by an actuator AC by means of the auxiliary toothed wheel RA.

As can be seen in FIG. 14, the magazine 92 comprises a plurality of coils 921 with horizontal axes, mounted on supports 922 rotating about respective vertical axes, the wires extending from the coils 921 as far as return pulleys 923 disposed in two columns, on each side of the guide means 93, and then as far as the radial guide arms 933 of the guide means 93.

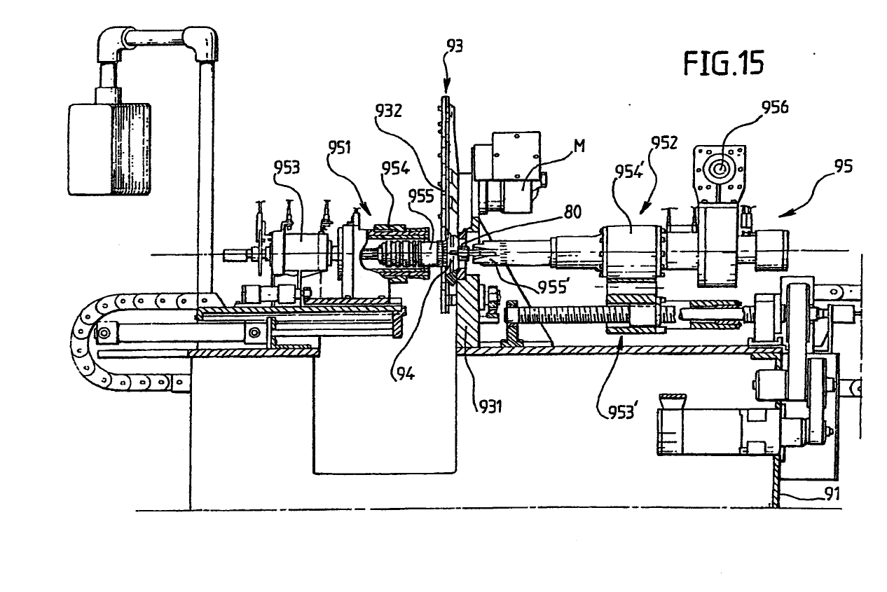

The means 95 of moving the dummy rotor 80 comprise a front unit 951 and a rear unit 952, visible in FIG. 15, disposed on the two opposite axial sides of the guide means 93, and means 953/953′ for axially moving the front and rear units 951 and 952.

The dummy rotor 80, at the winding station 94, is disposed so that its central axis 89 is aligned along the axis X-X′.

The front unit 951 comprises a body 954 and a head 955 free to rotate about the axis X-X′ with respect to the body 954, this head 955 being able to grip one end of the central spindle 89 of the dummy rotor 80 and comprising means of fixing the free ends 64 of the wires 60 at predetermined angular locking positions. These locking positions are distributed around the head 955 so as to be able to be brought into line radially with the guide tubes 934 by rotation of the head 955.

The rear unit 952 comprises a body 954′, a head 955′ able to grip the end of the central spindle 89 opposite to the front unit, and means 956 for driving the said head 955′ in rotation about the axis X-X′ with respect to the body 954′.

The means 953 for moving the front unit are disengageable, so that, once the two heads 955/955′ have gripped the dummy rotor 80, it is possible to move in a single piece the assembly formed by the two heads 955/955′, and the dummy rotor 80 in axial translation, using the means 953 for moving the rear unit 952, and in rotation about the axis X-X′, using the means 956 for driving the head 955′ in rotation.

The handling means 96 are able to grip a dummy rotor 80 to be wound in the storage zone 97, and to move it between this zone and a gripping position situated immediately in front of the winding station, the dummy rotor being oriented so that its central spindle 89 extends along the axis X-X′. The front and rear units 951 and 952 come to grip the dummy rotor in this position.

Once the winding of the dummy rotor 80 has ended, the front 951 and rear 952 units position the dummy rotor 80 once again in the gripping position and the handling means come to grip it in order to transfer it as far as the storage zone 97, after the front 951 and rear 952 units have released the dummy rotor 80.

All the elements of the machine are controlled by a computer (not shown).

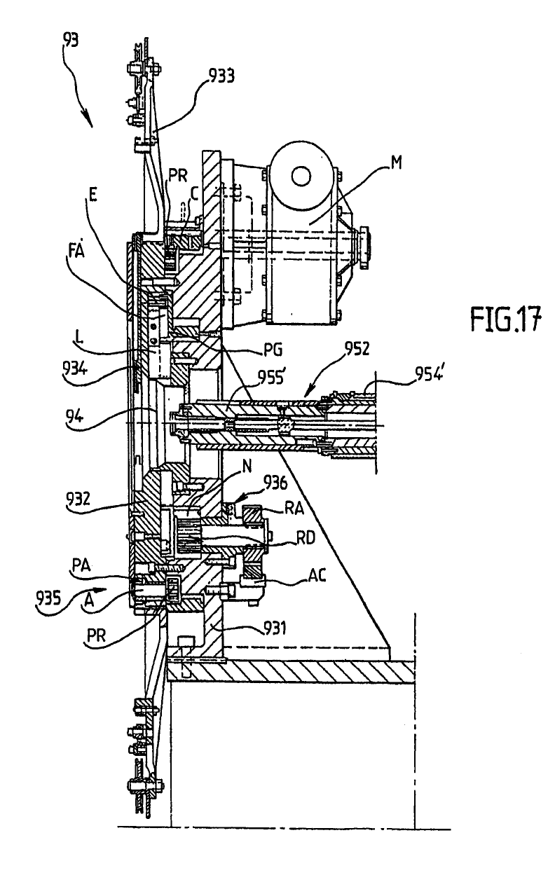

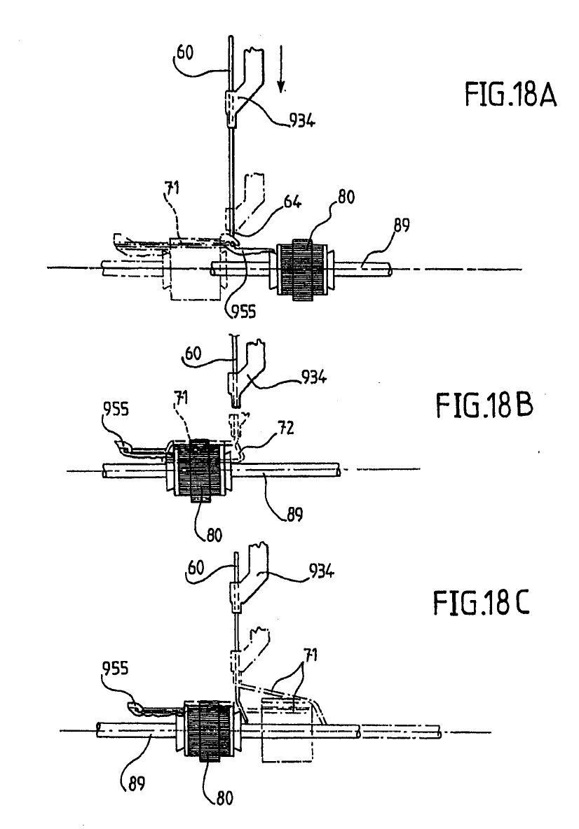

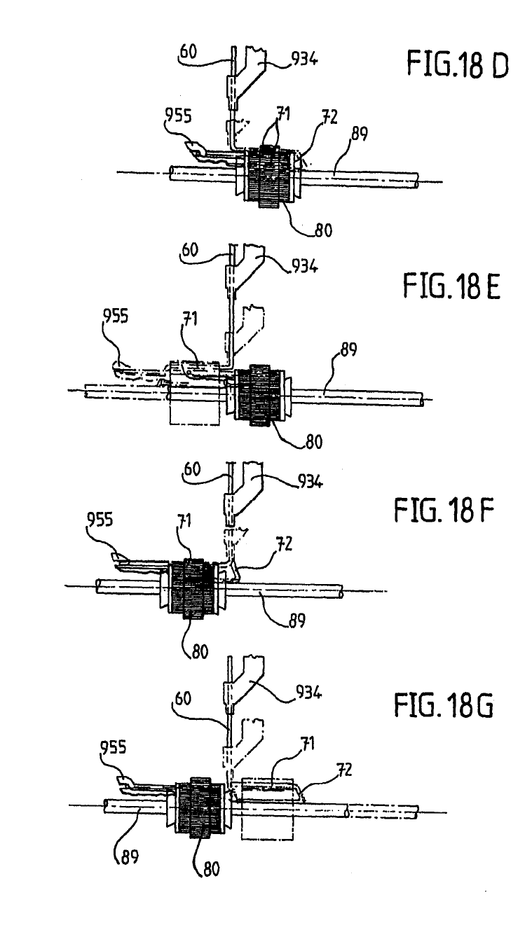

The cycle of winding the wires 60 on the dummy rotor 80 will now be described with reference to FIGS. 18A to 18G.

In the starting position, the two ends of the central spindle 89 of the dummy rotor 80 are locked in the heads 955/955′ of the front and rear units 951 and 952, and the dummy rotor 80 occupies its gripping position. The free ends 64 of the wire 60 project radially beyond the guide tubes 933.

The dummy rotor 80 and the two heads 955/955′ are then moved axially towards the rear and are oriented suitably so that the head 955 of the front unit 951 can grip the free ends 64 of the wires 60.

There is then the situation illustrated in solid lines in FIG. 18A. The winding sequence proper commences at this point.

The dummy rotor 80 is first of all moved axially forwards as far as the position illustrated in broken lines in FIG. 18A, the guide tubes 934 being at the same time moved radially inwards with the wires 60, over a length equivalent to the movement of the dummy rotor 80. The result of these conjoint movements is that the branches 71 are deposited axially at the bottom of the first group of radial slots 84.

The guide tubes 934 are then raised radially (solid lines in FIG. 18B), and are then once again moved inwards with the wires 60 in order to create the segments of connections 72 extending between the first group of radial slots 84 and the second group. During the inward movement of the tubes 934, the dummy rotor 80 undergoes a rotation about the axis X-X′ and at the same time undergoes a short translation forwards (formation of the first segments 721) and then a short translation towards the rear (formation of the second segments 722). This is the situated illustrated in broken lines in FIG. 18B. The guide tubes 934 are then disposed opposite the radial slots 84 of the second group.

The guide tubes 934 are then raised radially (solid lines in FIG. 18C) by a length corresponding to the length of the branches 71, and then are once again moved inwards with the wires 60 in order to create the branches deposited in the second group of radial slots 84. During the inward movement of the tubes 934, the dummy rotor 80 undergoes a rearward translation. This is the situation illustrated in broken lines in FIG. 18C.

The guide tubes 934 are then raised radially (solid lines in FIG. 18D) by a length corresponding to the length of the connecting segment 72 between the second group of radial slots and the third group of radial slots, and then are once again moved inwards with the wires 60 in order to create these connection segments 72. During the inward movement of the tubes 934, the dummy rotor 80 undergoes a rotation about an axis X-X′ and at the same time undergoes a short rearward translation (formation of the first segment 721) and then a short forward translation (formation of the second segment 722). These connection segments 72 are disposed on a side opposite to the connection segments 72 formed at the step in FIG. 18B. This is the situation illustrated in broken lines in FIG. 18D. The guide tubes 934 are then disposed opposite the radial slots 84 of the third group.

FIGS. 18E to 18G illustrate the following steps, making it possible to deposit branches 71 in the third group of radial slots 84, to create connection segments 72 extending between the third and fourth group of slots 84 and to deposit branches 71 in the fourth group of slots 84. These operations are performed in accordance with the procedure described in relation to FIGS. 18A to 18C.

The winding operation continues in the same way until a complete turn of the dummy rotor 80 has been performed and the first layer of wires has been formed.

The other layers are formed in the same way.

If it is wished to reverse the direction of winding when passing from one layer to another, as in the examples of a winding sequence illustrated in FIGS. 9A to 9F, it suffices to make the dummy rotor 80 turn in one direction in order to form the first layer and in the opposite direction in order to form the second layer.

The shifting of a radial slot between two successive layers (see FIG. 9B, between the fourth and fifth layers) can be achieved very easily with the machine described above, as will easily be understood.

It is also possible to programme the machine in order to create loops at a predetermined point of the winding, for example between two layers, these loops being intended to be cut in order to create new entries and new exits (see for example FIG. 9E). For this purpose, it suffices to programme the machine so as to create elongated connection segments 72 between the last group of slots of the first layer and the first group of slots of the following layer, by providing a longer axial movement of the rotor during this step. The loops can then be cut conveniently.

In order to achieve the permutations of wires in pairs of the type illustrated in FIGS. 9D (third layer) and 9F (second and fourth layers), it is necessary to provide for the front plate 932 to be divided into two parts able to move with respect to each other, as illustrated schematically in FIG. 12.

In the case of a machine for winding six wires, the first part is rigidly fixed to the support plate 931 and carries the guide arms 933 and the guide tubes 934 associated with the first, third and fifth wires, these wires being numbered in the order in which they are disposed around the winding station 94.

The second part is able to move in rotation around the axis X-X′ with respect to the first and carries the guide arms 933 and the guide tubes 934 associated with the second, fourth and sixth wires. The movement of the second part can be achieved by any suitable means, for example by a motor whose shaft drives a toothed wheel meshing with a teeth provided on the second part.

The movement of the second part makes it possible to bring the first wire between the second and fourth wires, the third wire between the fourth and sixth wires, and the fifth wire on the outside of the sixth wire, thus achieving the required permutations in pairs.

### Locking of the Branches of the Wires in the Recesses in the Packet of Metal Sheets

This locking can be achieved by several different techniques.

According to a first variant embodiment, the branches 71 are locked in the recesses 30 by deformation of the cross-section of at least some branches 71.

In each recess, this deformation is effected on at least the branch 71 situated in the radially outermost position, that is to say the closest to the opening of the recess, so as to lock the other branches inside the recess. The deformation can be effected also on all the other branches of the recess.

The branches 71 that are deformed come into abutment on the two opposite walls of the recess 30.

The operation of deforming the cross-section of the branches 71 can be performed in several ways.

1) After insertion of all the branches in the recesses in the packet of metal sheets, by coming to press with a blade on the innermost branch of each recess.

2) After insertion of all the branches in the radial slots in the dummy rotor, by coming to press with the blades L of the compacting means 936 of the winding machine 90 on the outermost branch of each radial slot.

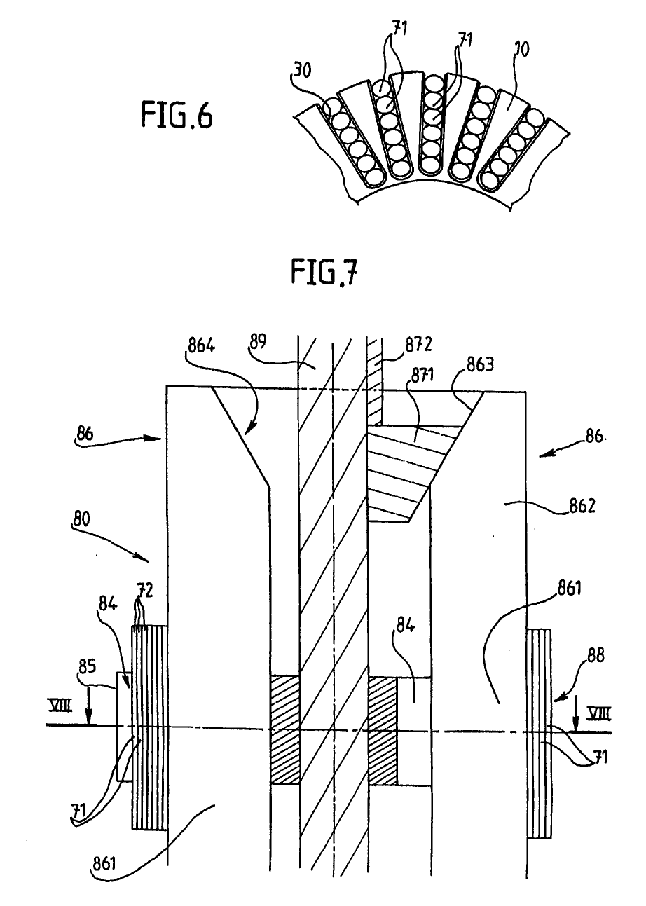

3) After the deposition of each layer in the radial slots of the dummy rotor, by coming to press with the blades L of the compacting means 936 of the winding machine 90 on the last branch deposited in each radial slot. The situation illustrated in FIG. 6 is then obtained.

4) By combining the above methods, and effecting the compacting both after the deposition of each layer in the radial slots in the dummy rotor and after transfer of the branches in the recesses of the packet of metal sheets.

It should be noted that the deformation of the branches in the slots in the dummy rotor in no way prevents the transfer of these branches into the recesses in the packet of metal sheets in accordance with the first embodiment of the stator, the force exerted by the actuator for moving the blades 86 of the dummy rotor 80 being very high and largely counterbalancing the resistance of resulting from the pressing of the branches 71 on the sides of the radial slots.

The locking of the branches in the recesses by deformation of the cross-section of the wires has the advantage of increasing the coefficient of filling of the recesses.

According to a second variant embodiment, the locking of the branches in the recesses is achieved by deformation of the internal edge of each tooth 35 (the root of the teeth), in a plurality of points distributed coaxially along the tooth root or over the entire axial length of the tooth root.

According to a third variant embodiment, the locking of the branches in the recesses is achieved by impregnating the wires with a resin after the insertion of these in the recesses.

It is possible to combine the three variant embodiments and to achieve for example a deformation of the cross-sections of the wires in order to increase the coefficient of filling of the recesses and locking by impregnation.

### Characteristics of the Stator Obtained in Accordance with the Method of the Invention

These stators have particular characteristics summarised below.

Such a stator comprises a corrugated coil 6 comprising a plurality of phase windings each formed by an electrically conductive wire 60 or several wires 60 in parallel. These wires are continuous, which means that they do not consist of several lengths welded end-to-end. On the other hand, when a phase winding comprises several parallel wires 60, the entry ends of these wires are joined by welding and the exit ends of these wires are joined by welding.

Each wire 60 is wound in a spiral around the bore 12 of the packet of metal sheets 10 and perform several turns 73 each corresponding to a turn of the bore 12, each turn 73 being incorporated in a different layer of the winding. The branches 71 of one and the same turn 73 are all disposed in reception positions of the recesses 30 in the packet of metal sheets 10 situated radially at the same level.

The recesses 30 in the stator have a circumferential width corresponding to the cross-section of the wire 60, all the branches 71 being aligned radially in a row in the same recess 30.

The coil 6 is wound so that the wires 60 of the windings pass in a first group of consecutive recesses 30, from a first axial side of the stator 1 as far as a second axial side opposite to the first, are then folded on the second axial side of the stator 1 in order to form a connection segment 72, then pass into a second group of consecutive recesses 30 situated alongside the first, from the second axial side as far as the first axial side, then are folded on the first axial side in order to form other connection segments 72, and so on over a first complete turn of the stator 1 constituting a first layer, the branches 71 of the first layer occupying the radially external reception positions 36 of all the recesses 30, the wires 60 being wound in the same way over one or more other turns and thus constituting one or more other layers of wires whose branches 71 occupy radially innermost reception positions 36 in the recesses 30.

The parts of the wires 60 constituting the connection segments 72 between a first group of recesses 30 and a second group of recesses 30 following the first in the winding order comprise first mutually parallel segments 721 forming a flat cluster emerging from the first group of recesses 30 in a direction inclined with respect to the axis of the stator as far as an axial top of the connection segment 72, and second mutually parallel segments 722 forming a flat cluster extending the first segments 721 from the said top as far as the second group of recesses 30, aslant with respect to the axis of the stator, so that the clusters of first and second segments 721/722 overlap mutually in a substantially triangular zone 724 at the top of the connection segments 722.

The flat clusters fit in a surface in a sector of a cylinder coaxial with the axis of symmetry 13 of the stator.

The second segments 722 still extend on a radially internal side of the first segments 721 in the triangular overlap zone 724.

The triangular overlap zones 724 of the given layer come to be inserted between the triangular overlap zones 724 of the previous layer, without overlapping them, even partially. As a result, if the coil is produced from an even number of pairs, the coil ends 40/40′ of the stator 1 have a constant radial thickness over the entire periphery of the stator. The radial thickness of the coil ends is the same as the radial thickness of the branches 71 aligned in the recesses 30.

However, if the winding is carried out with an odd number of wires, some zones will have a greater thickness, as explained above.

The coil ends obtained are thus particularly compact radially, the connection segments however being well ordered and designing air circulation passages, as can be seen in FIG. 3. Particularly advantageously, it is possible to modulate the cross-section of these passages by inclining the wires in the coil ends, as shown by FIG. 11. It is thus possible to optimise the cooling conditions.

In order to obtain coil ends that are particularly permeable to air, of the type depicted in FIG. 3, it is advantageous to provide for the connection segments 72 formed at the first step to have lengths increasing or decreasing along the same wire (FIG. 1). Length of a connection segment 72 means the length of the portion of the wire constituting this segment.

The turns 73 intended to be inserted first in the recesses 70, and whose branches 71 are inserted in radially external positions of bottoms of recesses 30, are conformed at the first step so that their connection segments 72 are relatively longer than those of the turns 73 whose lateral branches 71 occupy radially internal positions.

In the example in FIG. 3, all the connection segments 72 of the same turn 73 have the same length.

This length decreases evenly from one turn 73 to the following along the wire 60.

The different length between the connection segments 72 of the various turns 73 of the same wire compensates for the fact that the successive branches 71 of an external turn, disposed at the bottom of recesses 30, are mutually more separated than the branches 71 of an internal turn, whose branches are disposed at the entry to recesses 30.

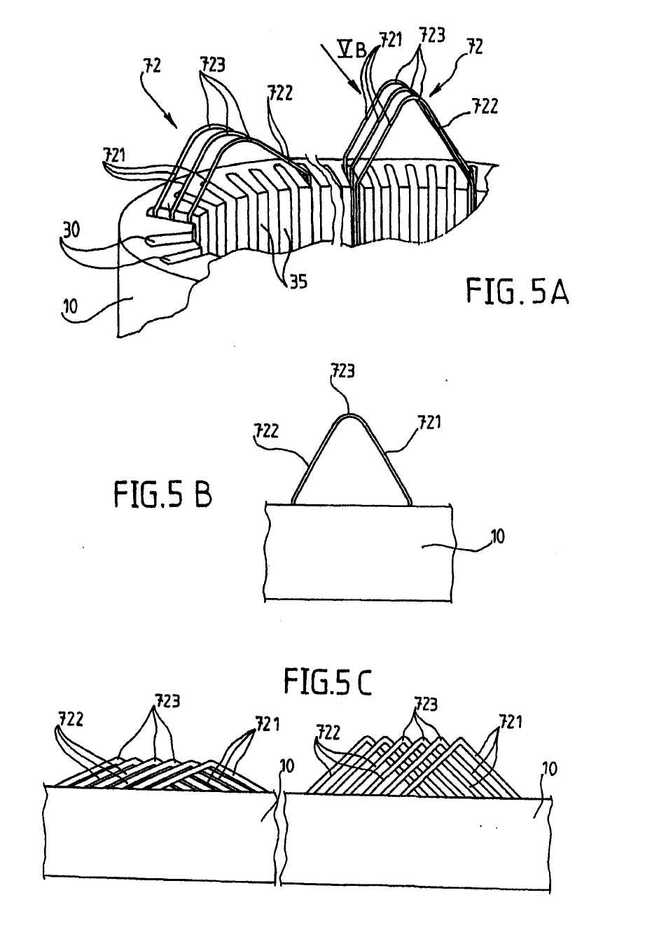

Once the turns are inserted in the packet of metal sheets 10, the connection segment 72 connecting the two external branches 71 will be more open than the external segment 72 connecting the two internal branches 71. Because of its greater opening, it will undergo a flattening that will return it to the same height as the connection segment 72 connecting the two internal branches 71 (see FIGS. 5A and 5B).

In this way coil ends where all the elements have the same axial height are obtained, as shown by FIG. 3.

In addition, all the segments issuing from the same end of a given recess in the stator are thereby substantially aligned radially in two directions, as shown by FIG. 5B.

In the example of a winding sequence in FIGS. 9A1 to 9A4, the segments issuing from the same axial end of a recess and forming part of the layers 1, 3 and 5 are mutually aligned and inclined on a first circumferential side. The segments forming part of the layers 2, 4 and 6 are mutually aligned radially and are inclined on a second circumferential side opposite to the first. The segments of layers 1, 3 and 5 form, with the segments of the layers 2, 4 and 6, a V where the recess end constitutes the tip (FIG. 5A).

In other sequences of windings, all the segments issuing from the same recess can be aligned on the same circumferential side of the recess.

In order to obtain coil ends that are very permeable to cooling air, the connection segments 72 are chosen so as to be relatively long (right-hand part of FIG. 5A). Thus, when the segments connecting a first group of recesses 30 to a second are considered, it is observed that the first segments 721 of these connection segments 72 are mutually parallel and separated (right-hand part of FIG. 5C). Likewise, the second segments 722 of these connection segments 70 are mutually parallel and separated.

In this way there are defined between the segments issuing from the various recesses a plurality of air passages extending radially through the coil ends, with a parallelepipedal cross-section, as can be seen in the right-hand part of FIG. 5C. These passages are disposed in the coil ends in a regular mesh, which promotes the circulation of air and the cooling of the coil ends.

It is also possible to obtain particularly compact coil ends by winding the wires so that the connection segments are contiguous once in place on the stator. The coil ends then have no passage of circulation of air passing through them. For this purpose, the lengths of the connection segments 72 are chosen so as to be relatively short (left-hand part of FIG. 5A). When the segments connecting a first group of recesses 80 to a second are considered, it can be seen that their first segments 721 are mutually parallel and contiguous or very slightly separated (left-hand part of FIG. 5C). Likewise their second segments 722 are mutually parallel and contiguous or very slightly separated. Naturally, the coil end in this case has a lower axial height than in the case of the well-ventilated coil end described above and illustrated on the right-hand part of FIG. 5C.

This configuration is advantageous in the case of stators with cooling by conduction towards the casing.

### Advantages of the Method Described Above and of the Stators Produced in Accordance with it

This method is adapted to practically all sizes of alternator for motor vehicles sold. The stators of these alternators comprise particularly a bore with a diameter of 80 to 120 mm, comprising 12 to 16 poles, that is to say a pole pitch of approximately 18 to 30 mm, preferably six recesses per pole. These characteristics are particularly advantageous since they are realistic in terms of manufacturability and performance.

In the case of alternator rectifiers, the method makes it possible to produce coils comprising two three-phase systems, mutually offset by 30° electrical, which are more efficient than simple three-phase systems.

However, for alternators with smaller pole pitches, on which it would not be possible, for technical or economic reasons, to put six recesses per pole, it is possible to produce only three recesses per pole and to form the coil according to the method of the invention, by winding using three wires instead of six.

Conversely, for machines with a greater pole pitch, it can be envisaged using 9, 12, 15 or more than 15 recesses per pole, and to form the coil according to the method of the invention using 9, 12, 15 or more than 15 wires. For example, it is possible to produce, with the method described above, a high-power alternator rectifier, 14 volts and 400 amperes, with 12 poles and 108 recesses, comprising a coil with three three-phase systems mutually offset by 20° electrical.

Moreover, the method described above makes it possible to produce stators having a high recess filling rate. It is possible to achieve filling rates of 65% (the ratio between the cross-section of the bare conductors and the cross-section of the recess).

The stators obtained have good thermal characteristics (good cooling of the coil ends because of the ventilated structure of these coil ends) and acoustic characteristics and good electrical efficiency.

In addition, the method does not generally include any welding step, which reduces the cycle time and limits the risk of defect in the coil. The only welds possibly necessary are small in number, for example six per stator, and concern the phase entries and exits (see the example embodiment in FIG. 9D).

The winding machines have great flexibility and can easily be adapted according to the characteristics of the stators to be produced: diameter and axial height of the packet of metal sheets, number of recesses and turns, cross-section of the wire, coupling of the phase windings in a star or delta.

1. A method of manufacturing a stator for a polyphase rotary electrical machine, such as an alternator or alternator/starter for a motor vehicle, this stator comprising a packet of metal sheets perforated centrally by a bore and having an axis of symmetry, recesses passing through axially formed in the packet of metal sheets around the bore, and a corrugated coil comprising a plurality of phase windings each formed by at least one continuous electrically conductive wire conformed in a succession of crenellations comprising a plurality of branches extending in a series of recesses and a plurality of connection segments connecting the branches, wherein said method comprises at least a first step during which the wires of the phase windings are disposed simultaneously on a dummy rotor and are, during this same operation, conformed in crenellations, the dummy rotor having, on a radially external face, a plurality of radial slots in which the branches of the windings are disposed, and a second step during which the dummy rotor is used for transferring the coil into the packet of metal sheets or for forming the stator.

2. The method according to claim 1, wherein the second step is performed by disposing the dummy rotor at the center of the packet of metal sheets and forcing the branches of the windings radially into the recesses from inside to outside.

3. The method according to claim 2, wherein the radial slots extend in respective radial planes regularly distributed around an axis of symmetry of the dummy rotor, the dummy rotor also comprising a plurality of blades disposed in the radial slots, and means of moving the blades radially from inside to outside in the radial slots, the branches of the windings coming to be inserted in the radial slots at the first step on a radially external side of the blades, the blades being moved radially towards the outside at the second step so as to transfer the branches of the radial slots into the recesses.

4. The method according to claim 1, wherein the stator is formed at the second step by fixing a cylindrical jacket around the dummy rotor.

5. The method according to claim 1, wherein the radial slots are equal in number to the number of recesses.

6. The method according to claim 1, wherein each radial slot has a circumferential width corresponding to the cross-section of the wire, so that the branches are all aligned radially in the slot.

7. The method according to claim 1, wherein the first step is performed by depositing the wires of the windings in a first group of consecutive radial slots, from a first axial side of the dummy rotor as far as a second axial side opposite to the first, folding the wires on the second axial side of the dummy rotor in order to form connecting segments, depositing the wires in a second group of consecutive axial slots situated alongside the first, from the second axial side as far as the first axial side, folding the wires on the first axial side in order to form other connecting segments, and so on until a first complete turn of the dummy rotor has been made and a first layer of wires has been formed, all the radial slots being occupied by one branch of a wire, and then in the same way making one or more other turns in order to form one or more other layers of wires in the radial slots.

8. The method according to claim 7, wherein each group of radial slots comprises a number of slots equal to the number of wires used to form the coil at the first step.

9. The method according to claim 7, wherein in the first layer, the branches of a given wire occupy a set of radial slots that is peculiar to this wire, and in that, in the other layer or layers, the branches of this same wire occupy the same set of radial slots.

10. The method according to claim 7, wherein in the first layer, the branches of a given wire occupy a set of radial slots that is peculiar to this wire, and in that, in at least one other layer, the branches of this same wire occupy another set of radial slots.

11. The method according to claim 10, wherein said other set of radial slots is offset by one slot with respect to the said set of radial slots.

12. The method according to claim 7, wherein in the first layer, the branches of a given wire occupy a first set of radial slots that is peculiar to this wire, in that, at least a second layer the branches of this same wire occupy a second set of radial slots different from the first set, and in that, in at least a third layer, the branches of this same wire occupy a third set of radial slots different from the first and second sets.

13. The method according to claim 7, wherein the wires of the phase windings are disposed in the same sequence in all the groups of slots, in a given layer of the coil.

14. The method according to any claim 7, wherein in the first layer, the wires of the phase windings are disposed in the same first given sequence in all the groups of slots and in that, in at least one other layer, the wires are disposed in a second sequence.

15. The method according to claim 14, wherein the coil comprises an even number of wires, the said second sequence being obtained from the first sequence by permuting the adjoining wires in pairs.

16. The method according to claim 7, wherein the first step is performed by winding an even number of wires each having an entry end and an exit end, these wires being joined in pairs after the first step by electrically connecting to each other the entry ends of the wires in the same pair and the exit ends of the wires in the same pair.

17. The method according to claim 7, wherein the parts of the wires constituting the connecting segments between a first group of radial slots and a second group following the first in the order of winding comprise first mutually parallel segments forming a flat cluster emerging from the first group of radial slots in a direction inclined with respect to the axis of the dummy rotor as far as an axial top of the connection segments, and second mutually parallel segments forming a flat cluster extending the first segments from the said top as far as the second group of radial slots, aslant with respect to the axis of the dummy rotor, so that the clusters of the first and second segments overlap mutually in a substantially triangular region at the top of the connection segments.

18. The method according to claim 17, wherein the second segments extend on a radially external side of the first segments in the substantially triangular region.

19. The method according to claim 17, wherein the substantially triangular region of a given layer come to be inserted between the substantially triangular region of the previous layer, without overlapping them even partially.

20. A stator for a polyphase rotary electrical machine, such as an alternator or alternator/starter for a motor vehicle, this stator comprising a packet of metal sheets perforated centrally by a bore and having an axis of symmetry, recesses passing through axially formed in the packet of metal sheets around the bore, and each having a plurality of reception positions distributed radially on several levels, and a corrugated coil comprising a plurality of phase windings each formed by at least one continuous electrically conductive wire conformed in a succession of crenellations comprising a plurality of branches disposed at reception positions in a series of recesses and a plurality of connection segments connecting the branches, wherein each wire is wound in a spiral around the bore and forms several turns (73) each corresponding to a turn of the bore, the branches in one and the same turn all being disposed in reception positions at the same level.

21. A stator according to claim 20, wherein the coil is wound so that the wires of the windings pass through a first group of consecutive recesses, from a first axial side of the stator as far as a second axial side opposite to the first, and are then folded on the second axial side of the stator in order to form connection segments, then pass into a second group of consecutive recesses situated alongside the first, from the second axial side as far as the first axial side, then are folded on the first axial side in order to form other connection segments, and so on over a first complete turn of the stator constituting a first layer, the branches of the first layer occupying the radially external reception positions of all the recesses, the wires being wound in the same way on one or more other turns and constituting one or more other layers whose branches occupy radially more internal reception positions in the recesses.

22. The stator according to claim 21, wherein the parts of the wires constituting the connection segments between a first group of recesses and a second group of recesses following the first in the winding order can comprise first mutually parallel segments forming a flat cluster emerging from the first group of recesses in a direction inclined with respect to the axis of the stator as far as an axial top of the connection segments, and second mutually parallel segments forming a flat cluster extending the first segments from the said top as far as the second group of recesses, aslant with respect to the axis of the stator, so that the clusters of the first and second segments overlap mutually in a substantially triangular region at the top of the connection segments.

23. The stator according to claim 22, wherein the second segments extend on a radially external side of the first segments in the substantially triangular region.

24. The stator according to claim 22, wherein the substantially triangular region of a given layer come to be inserted between the substantially triangular region of the previous layer, without overlapping them, even partially.

25. The stator according to claim 22, wherein the first and/or second segments issuing from the same end of a given recess can form a radial alignment on a circumferential side of the recess, or two V-shaped radial alignments of the two circumferential sides of the recess.

26. The stator according to claim 25, wherein the connection segments connecting a first group of recesses to a second group of recesses are relatively long, so that their first and second segments are mutually separated and define between them a plurality of radial air passages.

27. The stator according to claim 25, wherein the connection segments connecting a first group of recesses to a second group of recesses are relatively short, so that their first and second segments are mutually contiguous or mutually slightly separated.

28. The stator according to claim 20, wherein the recesses of the stator have a circumferential width corresponding to the cross-section of the wire, all the branches being aligned in the same recess.

29. An apparatus, comprising:
a) a drum containing drum slots along its outer surface;
b) at least one conductor in each slot;
c) a stator, surrounding the drum, and containing stator slots along its inner surface, each stator slot being aligned with a respective drum slot; and
d) a pusher for pushing the conductors from the drum slots into the stator slots.

30. The apparatus according to claim 29, wherein the conductors are electrically connected in series.

31. The apparatus according to claim 29, wherein the drum slots contain more than one conductor, and further comprising
e) a tamper for tamping the conductors into the drum slots.

32. The apparatus according to claim 29, and further comprising:
f) winding means for placing a single conductor into a selected sequence of the drum slots, prior to pushing the conductor into the stator slots.

33. The apparatus according to claim 29, and further comprising:
g) a deformer which deforms one or more of the conductors when positioned in the stator slots, to thereby capture the deformed conductors in the stator slots.

34. The apparatus according to claim 33, wherein a radially inner conductor in a stator slot is deformed, thereby capturing non-deformed conductors which are radially outward of that deformed conductor.

35. A method, comprising:
a) maintaining a drum containing drum slots along its outer surface;
b) threading a conductor through a sequence of the drum slots;
c) positioning the drum inside a stator having stator slots, such that the drum slots align with the stator slots;
d) moving the conductors from the drum slots into the stator slots; and
e) removing the drum from the stator.

36. The method according to claim 35, and further comprising:
f) placing more than one conductor into a drum slot; and
g) tamping the conductors in the drum slot.

37. The method according to claim 35, and further comprising:
g) deforming one or more of the conductors when positioned in the stator slots, to thereby capture the deformed conductors in the stator slots.

38. The apparatus according to claim 37, wherein a radially inner conductor in a stator slot is deformed, thereby capturing non-deformed conductors which are radially outward of that deformed conductor.

39. A method of constructing a stator for an electric motor, comprising:
a) constructing a hub having an array of radially extending teeth, which extend outwardly from the hub, each pair of adjacent teeth defining a slot there between;
b) placing stator windings into the slots; and
c) expanding a cylinder relative to the hub, and heat-shrinking the cylinder onto the hub, to thereby capture the windings between the hub and the cylinder.

40. An apparatus, comprising:
a) a first device which
i) weaves a first conductor through teeth on a dummy stator,
ii) weaves a second conductor through teeth on the dummy stator, and
iii) weaves a third conductor through teeth on the dummy stator,
to thereby create three electrical phases in the dummy stator;
b) a second device which
i) positions the dummy stator containing the conductors inside a machine stator, wherein teeth on the dummy stator are aligned with teeth on the machine stator; and
ii) pushes the conductors on the dummy stator into spaces between the teeth on the machine stator.

41. The apparatus according to claim 40, and further comprising:
c) means for deforming the conductors in the machine stator, to prevent removal of the conductors.

42. The apparatus according to claim 40, and further comprising:
d) a tamper for tamping the conductors between the teeth on the dummy stator.
